(19) United States
(12) Patent Application Publication
(10) Pub. No.: US 2005/0012594 A1
(43) Pub. Date: Jan. 20, 2005

(54) Key assemblies and methods

(76) Inventor: Youngtack Shim, Port Moody (CA)

Correspondence Address: Youngtack Shim, 155 Aspenwood Drive, Port Moody, BC, V3H 5A5, CA

(21) Appl. No.: 10/878,940

(22) Filed: Jun. 29, 2004

Related U.S. Application Data
(60) Provisional application No. 60/487,842, filed on Jul. 17, 2003.

(51) Int. Cl. G06F 7/00

(52) U.S. Cl. 340/5.72; 340/5.61

(57) ABSTRACT

The present invention generally relates to key assemblies and methods thereof for direct and remote control of operations of various devices including vehicles such as, e.g., automobiles or other land vehicles. More particularly, the present invention relates to a key assembly and related methods provided with a direct mechanism to directly lock and unlock a doors of a vehicle as well as a remote mechanism to lock and unlock the same door. Each of the direct and remote mechanisms is spatially disposed with respect to the other mechanism and/or operatively coupled to the other mechanism in order not to interfere the operation of the other mechanism and/or in order to reduce a characteristic dimension of such a key assembly. The key assemblies and related methods of this invention can be applied to any device of which the operations can be controlled by two or more different mechanisms, where one of such mechanisms may require a close disposition or a direct contact with the device for intended operations, while the other of such mechanisms does not require such a close disposition or direct contact for the same or similar intended operations.

The present application claims a benefit of an earlier filing date of a U.S. Provisional Application bearing a Ser. No. U.S. Ser. No. 60/487,842, which was filed on Jul. 17, 2003, and which is entitled “Key Assemblies and Methods,” an entire portion of which is incorporated by reference herein.

### FIELD OF THE INVENTION

The present invention generally relates to key assemblies and methods thereof for direct and remote control of operations of various devices including vehicles such as, e.g., automobiles or other land vehicles. More particularly, the present invention relates to a key assembly and related methods provided with a direct mechanism to directly lock and unlock a doors of a vehicle as well as a remote mechanism to lock and unlock the same door. Each of the direct and remote mechanisms is spatially disposed with respect to the other mechanism and/or operatively coupled to the other mechanism in order not to interfere the operation of the other mechanism and/or in order to reduce a characteristic dimension of such a key assembly. The key assemblies and related methods of this invention can be applied to any device of which the operations can be controlled by two or more different mechanisms, where one of such mechanisms may require a close disposition or a direct contact with the device for intended operations, while the other of such mechanisms does not require such a close disposition or direct contact for the same or similar intended operations.

### BACKGROUND OF THE INVENTION

With an advent of wireless technology, a variety of household appliances, vehicular devices, and industrial equipment can now be operated by remote controllers. For example, an automobile key assembly includes a conventional key unit for directly locking and unlocking a door of the automobile and igniting an engine thereof, and also includes a remote unit for remotely locking and unlocking the door and for other optional functions such as, e.g., activating and deactivating an alarm system of the automobile, igniting the engine, and the like.

One disadvantage of such a conventional configuration is that the key unit and the remote unit are provided as separate units so that a driver has to carry two bulky units in his or her key chain. To make the matters worse, the driver has to carry two or more key units and two or more remote units in the key chain when he or she has to drive more than one car. With these key and remote units in addition to other keys to his or her house and office, the key chain grows too bulky to be carried in his or her pocket.

In order to rectify such a problem, transmitters and switches therefor have been incorporated into a holder or handle of the key unit. Although such an embodiment offers the benefit of providing a compact key assembly, it has a great disadvantage of causing the drivers to accidentally actuate the switches and transmitters while turning on or off the engine, thereby unintentionally opening, closing, locking, and/or unlocking the doors.

Accordingly, there is a need for key assemblies and methods therefor to directly and remotely control the operations of various devices, while arranging different units of the key assemblies not to interfere operations of the other units.

### SUMMARY OF THE INVENTION

The present invention generally relates to key assemblies and methods thereof for direct and remote control of operations of various devices including vehicles such as, e.g., automobiles or other land vehicles. More particularly, the present invention relates to a key assembly and related methods provided with a direct mechanism to directly lock and unlock a doors of a vehicle as well as a remote mechanism to lock and unlock the same door. Each of the direct and remote mechanisms is spatially disposed with respect to the other mechanism and/or operatively coupled to the other mechanism in order not to interfere the operation of the other mechanism and/or in order to reduce a characteristic dimension of such a key assembly.

In a first aspect of the present invention, a key assembly is provided to directly and remotely control operations of a device. Such a key assembly may include a body, at least one key unit, and at least one transmitter unit. The key unit may be coupled to the body and arranged to directly control the operations of the device. The transmitter unit may be coupled to the body, include at least one switch to receive an user input, include at least one transmitter to transmit an output signal in response to the user input, and be arranged to remotely control the operations of the device through the output signal. In one embodiment, the key and transmitter units may be arranged to be spatially disposed to allow an user to directly control the operations of the device by the key unit without (or by minimizing) actuation of the switch of the transmitter unit. In another embodiment, the key unit and/or transmitter unit may be arranged to movably couple to the body and to move, e.g., between an exposed position and a hidden position so that the key assembly is arranged to have a shorter length and/or width when at least one of the units is in the hidden position than when such an unit is in the exposed position.

In another aspect of the present invention, a key assembly is provided to directly and remotely control operations of a vehicle. Such a key assembly may include a body, at least one key unit, and at least one transmitter unit. The key unit may be coupled to the body and arranged to directly control the operations of the vehicle. The transmitter unit may be coupled to the body, include at least one switch to receive an user input, include at least one transmitter to transmit an output signal in response to the user input, and be arranged to remotely control the operations of the vehicle through the output signal. In one embodiment, the key and transmitter units may be arranged to be spatially disposed to allow the user to directly control the operations of the vehicle by the key unit without or by minimizing actuation of the switch of the transmitter unit. In another embodiment, the key unit and/or transmitter unit may be arranged to movably couple to the body and to move, e.g., between an exposed position and a hidden position so that the key assembly is arranged to have a shorter length and/or width when at least one of the units is in the hidden position than when such an unit is in the exposed position.

In another aspect of this invention, key assemblies having mobile switches may be provided to directly and remotely lock and unlock doors of vehicles. Such a key assembly may include a body, at least one key unit, and at least one transmitter unit. At least a portion of the key unit is fixedly coupled to the body. The key unit may preferably include a preset shape, optical property, electrical property, and/or magnetic property and may be arranged to lock and unlock the door of the vehicle based on the preset shape and/or properties. The transmitter unit may be movably coupled to the body, arranged to move with respect to at least a portion of the body between at least one on-position and at least one off-position, have at least one switch arranged to receive an user input and at least one transmitter arranged to transmit an output signal in response to the user input, and arranged to remotely lock and unlock the door of the vehicle via the output signal. In one sub-aspect, at least a substantial portion of the switch of the transmitter unit may be arranged to be exposed in the on-position to be manipulated by the user. In addition, a non-negligible portion of the switch of the transmitter unit may be arranged to be covered by the body in the off-position so as to prevent (or to minimize) the user from actuating the switch and transmitting the output signal by the switch. In another sub-aspect, the key assembly may be arranged to have a shorter length and/or width when the transmitter unit is in the off-position than in the on-position. Such key assemblies may be constructed according to various embodiments. In the first embodiment, e.g., the body may define a cavity through which the non-negligible portion of the switch may be arranged to move between the on- and off-positions. Such a substantial portion of the switch may be arranged to be exposed out of the cavity of the body in the on-position, while such a non-negligible portion of the switch may be arranged to be disposed inside the cavity of the body in the off-position. In another embodiment, the body defines a similar cavity therein through which the non-negligible portion of the switch may be arranged to move between the on- and off-positions, and also defines at least one additional opening thereon. The transmitter unit may be arranged to expose the substantial portion of the switch through the opening of the body in the on-position and to render the non-negligible portion of the switch to be covered by, under or behind the body in the off-position, and the like. In yet another embodiment, the transmitter unit may include multiple switches disposed in different regions thereof. The body may include at least one guide along which the transmitter unit is arranged to move between at least one on-position and at least one off-position. The transmitter unit may be arranged to move from the off-position to the on-position to expose the substantial position of a first switch and to render the non-negligible portion of a second switch covered by the body, while to move from the on-position to off-position to expose a substantial portion of the second switch and to render a non-negligible portion of the first switch covered by the body. In yet another embodiment, at least a portion of the transmitter unit may be arranged to movably couple to the body so as to move across (or over) at least one surface of the body between the on-position and the off-position. The substantial portion of the switch may be arranged to be exposed out of the body in the on-position, whereas the non-negligible portion of the switch may be arranged to be covered by, under, below or behind the body in the off-position. In a further embodiment, the body may also be arranged to form a cavity inside which the transmitter unit is arranged to move between the on-position and off-position, and may further define at least one additional opening. Such a transmitter unit may be arranged to be disposed in one region of the cavity so as to expose the substantial portion of the switch through the opening of the body in the on-position, and to be disposed in another region of the cavity to render the non-negligible portion of the switch covered by the body in the off-position.

Embodiments of this aspect of the invention may include one or more of the following features.

The transmitter unit may be arranged to translate, rotate, and/or flip. Various mechanisms may be incorporated into the key assembly to drive, stop, and/or release the transmitter unit in one of such positions and/or from one position to the other. For example, the user may manually move the key unit from one to the other position using a handle of a manual mechanism. A recoil mechanism such as, a spring or coil, may be provided to store at least a portion of mechanical energy applied to the key unit by the user to move the switch from one position to the other and to utilize the stored energy to return the key unit to its original position. Conventional toggle mechanisms may also be incorporated in order to alternately or to cyclically move the key unit between the on-position and the off-position. Various curvilinear guides and/or axes of rotations may be incorporated into the key assemblies for various translational and/or rotational movements of the transmitter unit and/or switch thereof. The transmitter units may include multiple mobile parts each having at least one of such switches and/or transmitters. The transmitter unit may be constructed to have different configurations. For example, the transmitter unit may be arranged to move away from the key unit and/or the body from the off- to on-position (or vice versa), to move between opposing ends of the cavity (or body) between such positions (or vice versa), to pivot about or translate along a location(s) of the body. Contrary to the foregoing examples, the switch may be arranged to be exposed in the off-position and covered by or under the body in the on-position. The transmitter unit may be arranged to hide or cover only a portion (or an entire portion) of one switch in the off- (or on-) position. The transmitter unit and/or switch may also be arranged to move between multiple on- and/or off-positions to expose and/or to hide different sections thereof. In case the body should define the auxiliary openings, the switch may be disposed to be exposed out of the body and/or through the openings provided on or through the body. When multiple switches may be disposed to be alternately exposed out of the body and/or through such an opening in either of the positions, the transmitter unit may be arranged to hide or cover only a portion (or an entire portion) of one switch, while exposing merely a portion (or an entire portion) of the other switch. When such a transmitter unit includes more than two switches, two or more switches may be arranged to move in unison between such positions. In such an embodiment, the switches may also be disposed on one or both ends of the body, a middle of the body, and the like.

In another aspect of the present invention, key assemblies having movable key units may also be provided for directly and remotely locking and unlocking doors of vehicles. The key assembly may include a body, at least one key unit, at least one transmitter unit, and so on. The key unit may have a preset shape, optical property, electrical property, and/or magnetic property, be arranged to lock and to unlock the door of the vehicle based on such a shape and such properties, movably coupled to the body, and to move between at least one on-position and at least one off-position. The transmitter unit may be fixedly coupled to the body, have at least one switch arranged to receive an user input, and include at least one transmitter arranged to transmit an output signal responsive to the user input and to remotely lock and unlock the door of the vehicle through the output signal. In the first sub-aspect, at least a substantial portion of the key unit is arranged to be exposed out of the body to allow the user to lock and unlock the door by the portion of the key unit in the on-position and at least a non-negligible portion of such a key unit is arranged to be covered by, blocked by or disposed inside the body in the off-position. In another sub-aspect, the key assembly may also be arranged to have a shorter length when the key unit is in the off-position than in the on-position. In one embodiment, the body may form a receptacle and include an axis of rotation. The substantial portion of the key unit may be arranged to pivot about the axis along a first direction from the off-position to the on-position to dispose such a substantial portion of the key unit from or out of the receptacle. The key unit may then be arranged to pivot about the axis along a second direction (which may or may not be opposite to the first direction) from the on-position to the off-position in order to dispose the substantial portion of the key unit inside the receptacle. In another embodiment, the body may define a receptacle so that at least a substantial portion of the key unit is arranged to slide out of the receptacle from the off-position to the on-position to expose the portion of the key unit and that the substantial portion of the key unit is arranged to slide into the receptacle from the on-position to the off-position to dispose the same portion of the key unit inside the receptacle.

Embodiments of this aspect of the invention may include one or more of the following features.

Various mechanisms may be incorporated into the key assembly to move, stop, and/or release the key unit from one to the other of the on- and off-positions. For example, a manual mechanism may be provided such that the user may manually move the key unit from one to the other position. A recoil mechanism may be provided to store at least a portion of mechanical energy applied to the key unit by the user to move such from one to the other of such positions and to use the stored energy to return the key unit to its original position. Conventional toggle mechanisms may also be incorporated in order to alternately or cyclically move the key unit between the positions. Various curvilinear guides and/or axes of rotations may be provided to the key assembly various movements of the key unit as well. In addition, the receptacle may be provided to the body in different configurations. For example, such a receptacle may be defined between opposing surfaces of the body or on a surface of the body. The key unit may be arranged to translate and/or rotate parallel or perpendicular to a width or length of the body. The receptacle may be arranged to expose only a portion or an entire portion of the key unit in the on-position and to retain or hide only a portion or an entire portion of the key unit in the off-position. The key unit may also be arranged to have multiple on-positions and/or off-positions.

In another aspect of the present invention, various key assemblies having mobile covers may further be provided to directly and remotely lock and unlock doors of vehicles. Such a key assembly may include a body, at least one key unit, at least one transmitter unit, and at least one mobile cover. At least a portion of the key unit is fixedly coupled to the body, and the key unit has at least one of a preset shape, optical property, electrical property, and magnetic property, and arranged to lock and unlock the door of the vehicle based on the at least one of the shape and properties. The transmitter unit is fixedly coupled to the body and has at least one switch arranged to receive an user input and at least one transmitter arranged to transmit an output signal responsive to the user input. Thus, such a transmitter unit is arranged to remotely lock and unlock the door of the vehicle via the output signal. The cover is movably coupled to the body, key unit, and/or transmitter unit to move between at least one on-position and at least one off-position with respect to at least a portion of the transmitter unit. At least a substantial portion of the switch is arranged to be exposed in such an on-position, whereas a non-negligible portion of the switch is arranged to be covered by the cover in such an off-position. In one embodiment, such a cover may be movably disposed over a pair of opposing surfaces of the body and may be arranged to move over (or across) the opposing surfaces between the on- and off-positions. In another embodiment, the cover may be movably disposed over one surface of the body on which the switch is disposed and may be arranged to translate (or slide) between the on- and off-position along (or across) the surface of the body. In another embodiment, the cover may be movably disposed over a surface of the body on which the switch is disposed and may be arranged to rotate (or pivot) between the on- and off-positions over (or across) the surface of the body.

Embodiments of this aspect of the invention may include one or more of the following features.

The cover may be arranged to translate, slide, rotate, and/or pivot relative to other parts of the key assembly. Various mechanisms may be incorporated into the key assembly to move, stop, and/or release the cover in or from the on-position and/or off-position. Various curvilinear guides or axes of rotations may also be provided to guide various translational and/or rotational movements of the cover, where the cover may be arranged to translate or rotate along a length or a width of the key assembly and/or in a direction parallel to, in another direction perpendicular to or in yet another direction having a preset angle with respect to the surface of the body. The cover may also include multiple mobile parts arranged to cover and to dispose different switches of the transmitter unit or different units of the key assembly. The mobile cover may be provided according to various configurations. For example, the cover may be arranged to move away from one of the units (and body) from the off- to on-position (or vice versa), to move between opposing ends of the body between the off- and on-positions (or vice versa), and/or to pivot about or translate along a location(s) of the body. The cover may include one or more additional openings through which the switch may be exposed in the on-position. The cover and/or body may be arranged to expose merely a portion (or an entire portion) of the switch in the on-position, and to cover (or hide) merely a portion or an entire portion of the switch in the off-position. In addition, the cover may be arranged to have multiple on- and/or off-positions to expose and/or to hide different portions of the switch.

In another aspect of the present invention, various key assemblies having mobile key units and mobile transmitter units may be provided to directly and remotely lock and to unlock a door of a vehicle. Such a key assembly may include a body, at least one key unit, and at least one transmitter unit. Such a key unit may be arranged to have a preset shape (protrusions and/or indentations), optical property, electrical property, and/or magnetic property to lock and unlock the door of the vehicle based on such shapes and/or properties, to be movably coupled to the body, and to move between at least one on-position and at least one off-position. The transmitter unit may also be movably coupled to the body, move with respect to at least a portion of the body between at least one on-position and at least one off-position, have at least one switch arranged to receive an user input and at least one transmitter arranged to transmit an output signal in response to the user input, and arranged to remotely lock and unlock the door of the vehicle through the output signal. More particularly, the mobile key unit and the mobile transmitter units are arranged to move independently between their own on- and off-positions or, alternatively, to be operatively coupled to each other so that one of such units may be arranged to move to (or stay in) in one of its on- and off-positions as the other of such units may be arranged to move to (or stay in) in one of its on- and off-position.

In another aspect of this invention, various key assemblies including mobile covers coupled to stationary and/or mobile key and mobile transmitter units may be provided to directly and remotely lock and to unlock a door of a vehicle. Such a key assembly may include a body, at least one key unit, at least one transmitter unit, and at least one cover. Such a key unit is arranged to have a preset shape, electrical property, optical property, and/or magnetic property so as to lock and unlock the door of the vehicle based on such shapes and/or properties. The transmitter unit may include at least one switch arranged to receive an user input and at least one transmitter arranged to transmit an output signal in response to the user input, and may be arranged to remotely lock and to unlock the door of the vehicle through the output signal. Such a cover may be movably coupled to the body, key unit, and transmitter unit to move between at least one on-position and at least one off-position relative to at least a portion of the body. In one embodiment, the key and/or transmitter units may be movably coupled to the body to move between at least one on-position and at least one off-position, and the cover may operatively be coupled to the key and/or transmitter units such that one of such units may be arranged to move to (or to stay in) one of its on- and off-positions as the cover moves from one of its on- and off-positions to the other of its on- and off-positions. The cover may include a temporal coupling mechanisms or a spatial coupling mechanism to temporally or spatially synchronize movements between the cover and the key unit and/or transmitter unit. The cover and mobile unit may also be arranged to move different distances or to rotate different angles in moving from one of their own positions to the other of their positions. In another embodiment, both of the key and transmitter units may be movably coupled to the body to move between at least one on-position and at least one off-position of their own. The cover may be operatively coupled to at least one of the key and transmitter units such that one of said units may be arranged to move to (or to stay in) one of its on- and off-positions as the cover moves from one of its on- and off-positions to the other of its on- and off-positions. One or both mobile units may be operatively coupled to the cover. The cover may also include a temporal coupling mechanisms or a spatial coupling mechanism to temporally or spatially synchronize movements between the cover and the key unit and/or transmitter unit. The cover and mobile unit may also be arranged to move different distances or to rotate different angles when they move from one of their own positions to the other of their positions.

In another aspect of the present invention, various key assemblies with various disablers may be provided to directly and remotely lock and unlock doors of vehicles. The key assembly may include a body, at least one key unit, at least one transmitter unit, and at least one disabler. The key unit may be either fixedly or movably coupled to the body and have a preset shape, optical property, electrical property, and magnetic property to lock and unlock the door of the vehicle based on the shape and/or properties. The transmitter unit may be either fixedly or movably coupled to the body, include at least one switch for receiving an user input and at least one transmitter for transmitting an output signal in response to the user input, and arranged to remotely lock and unlock the door of the vehicle through the output signal. The disabler may be fixedly or movably coupled to one of the body, key unit, and/or transmitter unit and arranged to be deactivated and activated by the user. The deactivated disabler is arranged to allow the switch to receive the user input and then to allow the transmitter to transmit the output signal, whereas the activated disabler is arranged to block the transmitter unit from transmitting the output signal by blocking the switch from receiving the user input, by blocking the transmitter from generating and/or from transmitting the output signal, and the like. In one embodiment, the disabler may be arranged to be operatively coupled to the switch and arranged to block the switch from receiving the user input when activated. In another embodiment, the disabler may be arranged to be operatively coupled to the transmitter and to prevent the transmitter from generating and/or transmitting the output signal when activated. In yet another embodiment where the door of the vehicle has a lock assembly, the disabler may include a sensor capable of sensing insertion of the key unit into the lock assembly.

Upon sensing such an insertion, the disabler may be arranged to disable the switch and/or transmitter, e.g., by preventing the switch from receiving the user input, by blocking the switch from activating the transmitter unit, by preventing the transmitter from generating the output signal in response to the user input, preventing the transmitter from transmitting the output signal, and the like.

Embodiments of this aspect of the invention may include one or more of the following features.

The switches of the transmitter unit may be arranged to operate based on different modes of operation, and the disabler may be arranged accordingly. For example, the switch may be displaced, e.g., pushed, translated, tilted, rotated, and otherwise selected, in response to the user input, and the disabler may be arranged to block or impede the displacement of the switch mechanically, electrically, magnetically, and/or optically. Alternatively, the switch may be arranged to be selected without being displaced (e.g., touched), and the disabler may be arranged to prevent such a selection mechanically, electrically, magnetically, and/or optically. In another alternative, the disabler may be arranged to block the transmitter from being activated, from generating the output signal, and from transmitting the output signal mechanically, electrically, magnetically, and/or optically. The disabler itself may be activated by being pushed, translated, tilted, rotated, touched, and the like. Various mechanisms may be provided to activate, hold, and/or release the disabler as well. The sensor of the disabler may be arranged to detect the partial or complete insertion of the key unit into the lock assembly by sensing or measuring, e.g., existence of the lock assembly in its vicinity, distance to the lock assembly, horizontal, vertical or lateral force applied to the sensor, torque applied to the sensor, horizontal, vertical, lateral or angular displacement of the key unit due to the force applied by the user, electric voltage or current supplied to the sensor, change in resistance, and the like. The disabler may also be arranged to have multiple selections to disable different switches.

In another aspect of the present invention, various key assemblies may be provided to directly and remotely lock and unlock doors of vehicles. Such a key assembly includes a body having at least one major surface and at least one minor surface, at least one key unit, and at least one transmitter unit. The key unit may be either fixedly or movably coupled to the body and may have a preset shape, optical property, electrical property, and magnetic property to lock and unlock the door of the vehicle based on the shape and/or properties. The transmitter unit may be either fixedly or movably coupled to such a body, include at least one switch for receiving an user input and at least one transmitter for transmitting an output signal in response to the user input, and arranged to remotely lock and unlock the door of the vehicle through the output signal, where at least a non-negligible portion of the switch may be arranged to be disposed on the minor surface. Such a major and/or minor surface of the body may be defined on a top, bottom, and side of the key assembly and, thus, the switch of the transmitter unit may be disposed on an edge or side of the key assembly.

In another aspect, a method may be provided for directly and remotely controlling operations of a device or a vehicle using a key assembly with a body. Such a method include the steps of coupling to the body at least one transmitter unit capable of remotely controlling the operations, coupling to the body at least one key unit capable of directly controlling the operations, and spatially arranging such a transmitter unit and/or key unit to allow manipulation of the key unit without (or by minimizing) actuation (or activation) of the transmitter unit, thereby preventing accidental actuation of such operations of the device (or vehicle) and/or minimizing actuation of unintended operations thereof. In the alternative, the method may include the steps of coupling to the body at least one transmitter unit capable of remotely controlling the operations, coupling to the body at least one key unit capable of directly controlling the operations, spatially arranging at least one of the transmitter unit and/or key unit to move between an exposed position and a hidden position, controlling the operations of the device (or vehicle) when the at least one of the units is placed in the exposed position, and then moving the mobile unit to its hidden position upon completion of such operations, thereby decreasing a total length and/or width of the key assembly than when the mobile unit is in the exposed position.

In another aspect, a method may be provided for directly and remotely locking and unlocking a door of a vehicle by a key assembly which includes a body, at least one key unit capable of directly locking and unlocking the door, and at least one movable transmitter unit including at least one switch capable of receiving an user input and at least one transmitter capable of transmitting an output signal toward the door to remotely lock and unlock the door. Such a method may include the steps of fixedly coupling the key unit to the body, movably coupling the transmitter unit to the body, exposing at least a substantial portion of the switch to receive the user input thereby, and hiding at least a non-negligible portion of the switch to block reception of the user input. An alternative method may include the steps of fixedly coupling the key unit to the body, movably coupling the transmitter unit to the body, moving or extending at least a substantial portion of the switch to receive the user input, and then retracting the same or similar portion of the switch after receiving the user input to reduce a length and/or width of the key assembly.

In another aspect, a method may be provided for directly and remotely locking and unlocking a door of a vehicle by a key assembly which includes a body, at least one movable key unit capable of directly locking and unlocking the door, and at least one transmitter unit including at least one switch capable of receiving an user input and at least one transmitter capable of transmitting an output signal toward the door to remotely lock and unlock the door. The method may include the steps of movably coupling the key unit to the body, fixedly coupling the transmitter unit to the body, exposing at least a substantial portion of the key unit to lock and unlock the door, and then hiding at least a non-negligible portion of the key unit after locking and unlocking the door. In the alternative, the method may include the steps of movably coupling the key unit to the body, fixedly coupling the transmitter unit to the body, extending at least a substantial portion of the key unit to lock and unlock the door, and retracting such a portion of the key unit after locking and unlocking the door, thereby reducing a length and/or width of the key assembly.

In another aspect, a method may be provided for directly and remotely locking and unlocking a door of a vehicle by a key assembly which includes a body, at least one key unit capable of directly locking and unlocking the door, and at least one movable transmitter unit including at least one switch capable of receiving an user input and at least one transmitter capable of transmitting an output signal toward the door to remotely lock and unlock the door. Such a method may include the steps of either fixedly or movably coupling the key unit to the body, either fixedly or movably coupling the transmitter unit to the body, movably coupling at least one cover to the body, key unit, and/or transmitter unit, then moving the cover along one direction, thereby exposing at least a substantial portion of the switch and receiving the user input by the switch, and moving the cover in another direction, thereby covering or hiding at least a non-negligible portion of the switch and blocking reception of the user input.

In yet another aspect, a method may further be provided for directly and remotely locking and unlocking a door of a vehicle by a key assembly which includes a body, at least one key unit capable of directly locking and unlocking the door, at least one transmitter unit with at least one switch capable of receiving an user input and at least one transmitter capable of transmitting an output signal toward the door to remotely lock and unlock the door, and at least one disabler capable of blocking a intended function of the key unit and/or the transmitter unit. Such a method may include the steps of fixedly or movably coupling the key unit to the body, fixedly or movably coupling the transmitter unit to the body, operatively coupling the disabler to the transmitter unit, deactivating the disabler to allowing the switch to receive the user input and to allow the transmitter unit to generate and to transmit the output signal, and activating the disabler to block the switch from receiving the user input, to prevent the transmitter from generating the output signal, and to block the transmitter from transmitting the output signal.

In another aspect of the present invention, a key assembly for directly and remotely controlling operations of a device (or vehicle) may be made by a variety of processes. In one embodiment, such a process may include the steps of providing a body of such a key assembly, coupling to the body at least one transmitter unit capable of remotely controlling the operations, coupling to the body at least one key unit capable of directly controlling the operations, and spatially arranging the transmitter unit and/or the key unit to allow manipulation of the key unit without actuating the transmitter unit or while minimizing activation of the transfer unit, thereby preventing unintended operations of such a device (or vehicle). In an alternative embodiment, the process may include the steps of providing a body of the key assembly, coupling to the body at least one transmitter unit capable of remotely controlling the operations, coupling to the body at least one key unit capable of directly controlling such operations, spatially arranging the transmitter unit and/or key unit to move between at least one exposed position and at least one hidden position, controlling the operations of the device when the mobile unit is placed in the exposed position, and then moving the mobile unit back to its hidden position upon completion of the operations, thereby reducing a total length and/or width of the key assembly in the hidden position than in the exposed position.

In yet another aspect of this invention, a key assembly for directly and remotely unlocking and locking doors of vehicles may be provided by various processes, where the key assembly includes a body, at least one key unit for directly locking and unlocking the door, and at least one transmitter unit including at least one switch for receiving an user input and at least one transmitter for transmitting an output signal toward the door to remotely lock and unlock the door. In one embodiment, the process may include the steps of fixedly coupling the key unit to the body, movably coupling the transmitter unit to the body, exposing at least a substantial portion of the switch to receive the user input thereby, and hiding at least a non-negligible portion of the switch to prevent reception of the user input. In another embodiment, the process may include the steps of fixedly coupling the key unit to the body, movably coupling the transmitter unit to the body, extending at least a substantial portion of the switch, thereby receiving the user input, and retracting the portion of the switch after receiving the user input, thereby reducing a length and/or width of the key assembly. In another embodiment, the process may include the steps of movably coupling the key unit to the body, fixedly coupling the transmitter unit to the body, exposing at least a substantial portion of the key unit to lock and unlock the door, and hiding at least a non-negligible portion of the key unit after locking and unlocking the door. In yet another embodiment, the process may include the steps of movably coupling the key unit to the body, fixedly coupling the transmitter unit to the body, extending at least a substantial portion of the key unit to lock and unlock the door, and retracting the substantial portion of the key unit after locking and/or unlocking the door, thereby reducing a length and/or width of the key assembly. In another embodiment, the process may further include the steps of coupling the key unit to the body, coupling the transmitter unit to the body, movably coupling at least one cover to at least one of the body, key unit, and transmitter unit, moving the cover along one direction, thereby exposing at least a substantial portion of the switch and then receiving the user input thereby, and moving the cover in another direction, thereby covering or hiding at least a non-negligible portion of the switch and blocking reception of the user input. In yet another embodiment, the process includes the steps of fixedly or movably coupling the key unit to the body, fixedly or movably coupling the transmitter unit to the body, operatively coupling at least one disabler to the transmitter unit, deactivating the disabler, thereby allowing the switch to receive the user input and allowing the transmitter unit to generate and to transmit the output signal, and then activating the disabler, thereby preventing the switch from receiving the user input, preventing the transmitter from generating the output signal, and/or blocking the transmitter from transmitting the output signal. In yet another embodiment, another process may also include the steps of coupling the key unit to the body, coupling the transmitter unit to the body, operatively coupling at least one disabler to the transmitter unit, deactivating the disabler, thereby allowing the switch to receive the user input and allowing the transmitter unit to generate and to transmit the output signal, and then activating the disabler, thereby blocking the switch from receiving the user input, preventing the transmitter from generating the output signal, and/or blocking the transmitter from transmitting the output signal.

As used herein, a “device” generally refers to any household appliances, industrial equipment, vehicles, construction parts, and any other articles whose operations may be controlled by more than one mechanism each requiring a different mode of manipulation. Therefore, a key assembly of such a “device” generally includes multiple units each of which is arranged to perform a specific manipulation. For example, a key assembly of a vehicle such as an automobile includes a key unit and a transmitter unit, where the former allows an user to directly and manually lock a vehicle door, unlock the door or to turn on or off an engine of the vehicle, while the latter allows the user to remotely lock or unlock the door and/or activate or deactivate an alarm system thereof. In such a case, two different units of the key assembly may perform generally similar functions by different methods, i.e., the former requires a direct or manual contact with the “device,” while the latter does not require such a contact. In another example, a key assembly of an office may include a key unit and a magnetically, electrically or optically encoded unit, where the former allows the user to lock and unlock a mechanical lock assembly, while the latter allows the user to gain an access through a magnetic, electric or optical access surveillance system. In such a case, two different units of the key assembly perform generally different functions by the similar method, i.e., both units require a direct contact with the devices.

Unless otherwise defined in the following specification, all technical and scientific terms used herein have the same meaning as commonly understood by one of ordinary skill in the art to which the present invention belongs. Although the methods or materials equivalent or similar to those described herein can be used in the practice or in the testing of the present invention, the suitable methods and materials are described below. All publications, patent applications, patents, and/or other references mentioned herein are incorporated by reference in their entirety. In case of any conflict, the present specification, including definitions, will control. In addition, the materials, methods, and examples are illustrative only and not intended to be limiting.

Other features and advantages of the present invention will be apparent from the following detailed description, and from the claims.

### BRIEF DESCRIPTION OF THE DRAWING

FIGS. 1A to 1L are schematic diagrams of exemplary key assemblies having a variety of mobile transmitter units moving between off-positions and on-positions according to the present invention;

FIGS. 2A to 2D are schematic diagrams of exemplary key assemblies having a variety of mobile key units moving between off-positions and on-positions according to the present invention;

FIGS. 3A to 3H are schematic diagrams of exemplary key assemblies having a variety of mobile covers moving between off-positions and on-positions according to the present invention;

FIGS. 4A to 4H are schematic diagrams of exemplary key assemblies having a variety of mobile transmitter units and mobile key units moving between off-positions and on-positions according to the present invention;

FIGS. 5A to 5D are schematic diagrams of exemplary key assemblies having a variety of mobile or fixed key or transmitter units operationally coupled to mobile covers moving between off-positions and on-positions according to the present invention;

FIGS. 6A to 6F show schematic diagrams of exemplary key assemblies incorporating a variety of disablers according to the present invention; and

FIGS. 6G and 6H are schematic diagrams of exemplary key assemblies having transmitter units disposed on minor surfaces thereof according to the present invention.

### DETAILED DESCRIPTION OF THE PREFERRED EMBODIMENTS

The present invention generally relates to key assemblies and methods thereof for direct and remote control of operations of various devices including vehicles such as, e.g., automobiles or other land vehicles. More particularly, the present invention relates to a key assembly and related methods provided with a direct mechanism to directly lock and unlock a door of a vehicle as well as a remote mechanism to lock and unlock the same door. Each of the direct and remote mechanisms is spatially disposed with respect to the other mechanism and/or operatively coupled to the other mechanism in order not to interfere the operation of the other mechanism and/or in order to reduce a characteristic dimension such as a length or a width of the key assembly. Following description provides details of various aspects and embodiments of such key assemblies and related methods. It is noted, however, that the following description is intended to illustrate and not to limit the scope of the present invention.

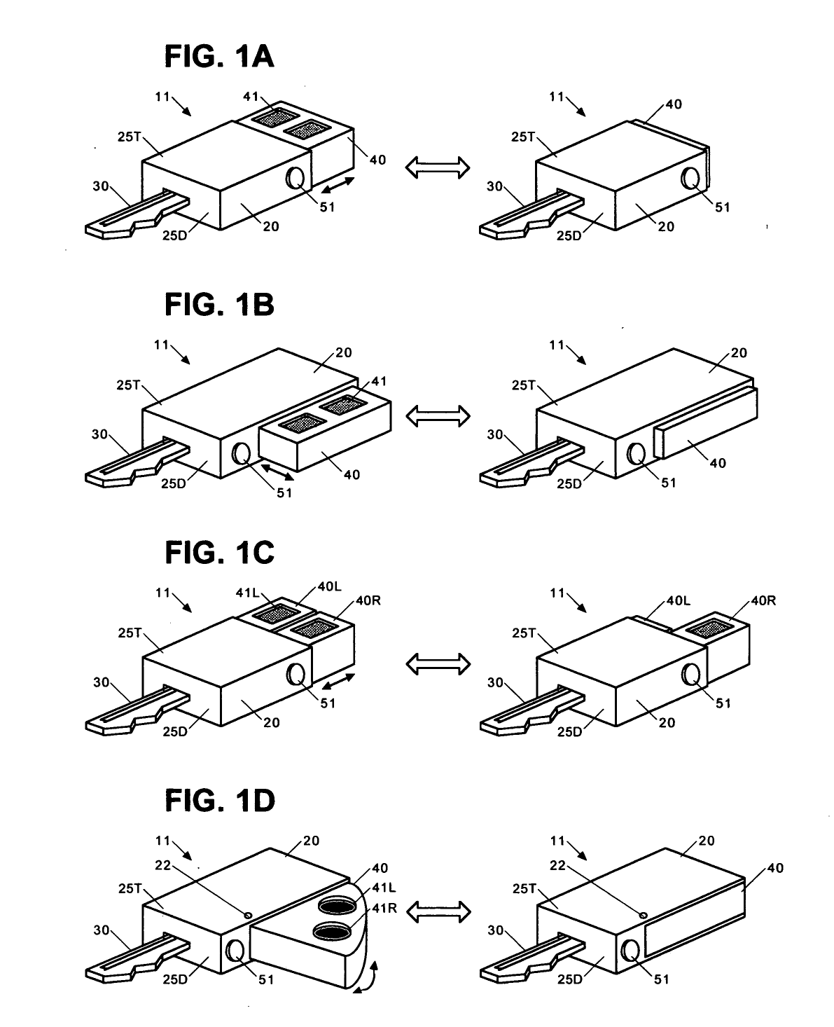

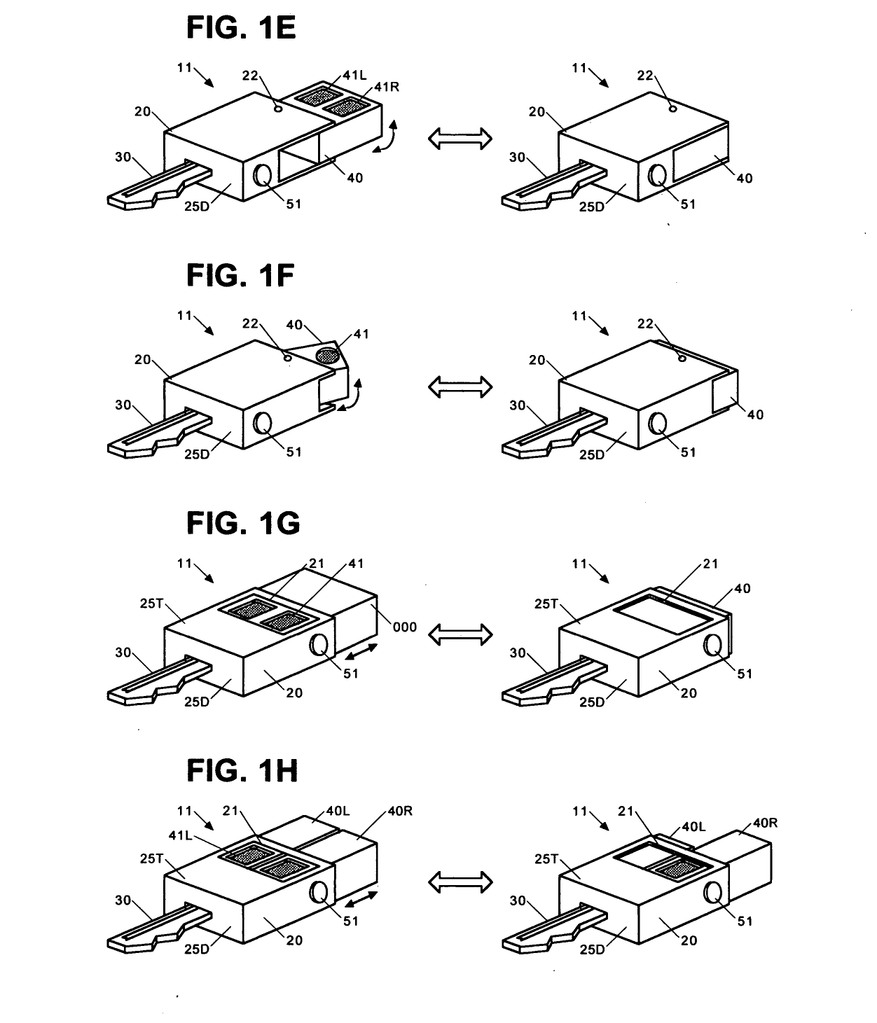

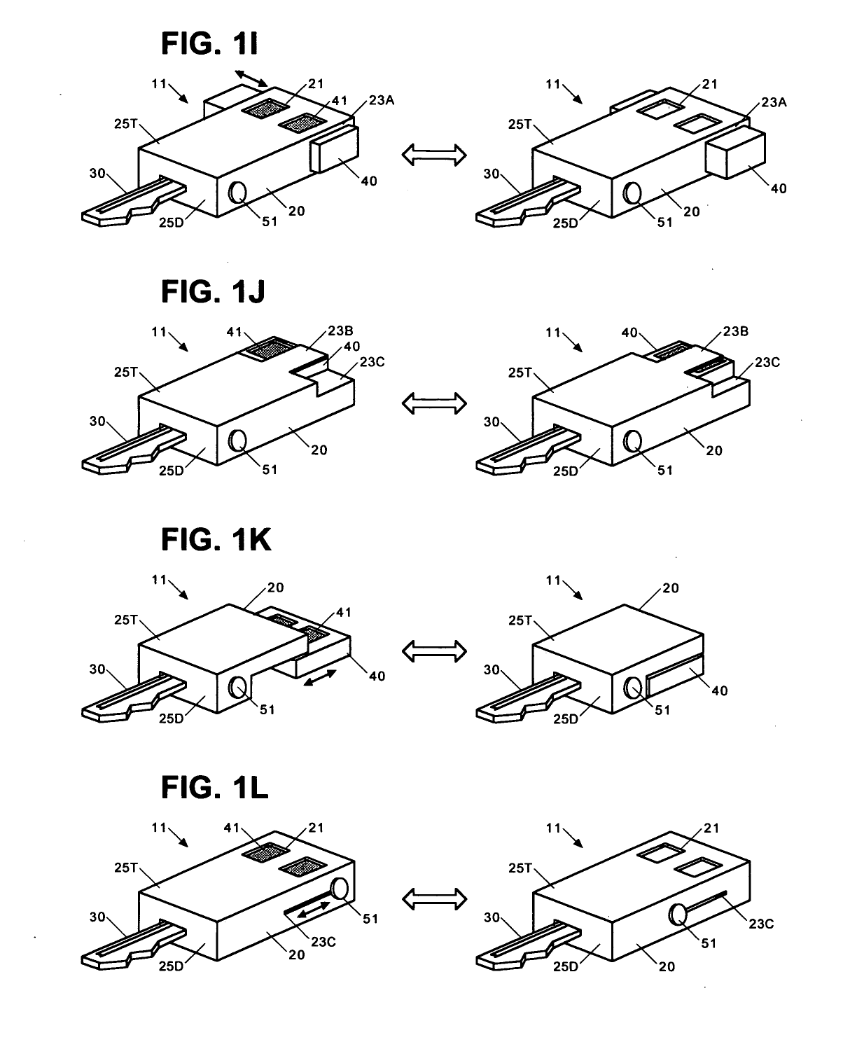

In one aspect of this invention and as exemplified in FIGS. 1A to 1L, exemplary key assemblies may incorporate various mobile units arranged to move between off-positions and on-positions and to remotely control various operations of the devices. Such an exemplary key assembly 11 may include a body 20, at least one key unit 30, and at least one transmitter unit 40. As shown in the figures, the body 20 constitutes a main component of the key assembly 11. The key unit 30 is arranged to have a preset shape, e.g., protrusions and indentations provided therealong in a preset arrangement, so as to directly and/or manually lock and unlock a lock assembly of a vehicle. At least a portion of the key unit 30 is fixedly coupled to the body 20, e.g., a distal end 25D of the body 20, in the above embodiments. Contrary to the fixedly coupled key unit 30, the transmitter unit 40 is movably coupled to the body 20 to move between at least one on-position and at least one off-position thereof with respect to at least a portion of the body 20 and/or the key unit 30. The transmitter unit 40 also includes at least one switch 41 and at least one transmitter (not shown in the figures), where the switch 41 is arranged to receive an user input and where the transmitter is arranged to transmit an output signal responsive to the user input to remotely lock and unlock the door of the vehicle through the output signal. The transmitter unit 40 is preferably constructed such that at least a substantial portion of the switch 41 may be exposed in the on-position and readily manipulated by the user, whereas at least a non-negligible portion of the switch 41 may be hidden or covered by the body 20 in the off-position so as to prevent the user from accidentally actuating the switch 41 to transmit the output signal from the transmitter. Accordingly, the key assembly 11 may be constructed to have a shorter length and/or width when the transmitter unit 40 is in its off-position than in its on-position. The key assemblies 11 of such an aspect of the present invention may be constructed according to various embodiments.

FIGS. 1A to 1F show schematic diagrams of exemplary key assemblies with mobile transmitter units arranged to move through cavities of the body, in which the figures on the left-side describe the mobile transmitter units disposed in the on-positions and those on the left-side display such transmitter units disposed in the off-positions according to the present invention. For example, the body 20 of the key assembly 11 defines therein a cavity (not shown and numbered) generally shaped and/or sized to receive the non-negligible portion of the switch 41 therein so as to allow translational (FIGS. 1A to 1C) and/or rotational (FIGS. 1D to 1F) movements of the switch 41 and/or transmitter unit 40 therethrough. In particular, the transmitter units 40 are arranged to translate between the positions along the length (FIGS. 1A and 1C) or width of the body (FIG. 1B) and/or to rotate or pivot between the positions about a location of (or on) the body 20 such as, e.g., axes of rotations 22 (FIGS. 1D to 1F). Accordingly, the substantial portion of the switch 41 is exposed outside of (or from) the cavity of the body 20 when the transmitter unit 40 is in (or moves to) the on-position, while the non-negligible portion of the switch 41 is disposed inside the cavity of the body 20 (or covered thereby) when the transmitter unit 40 is in (or moves to) the off-position. The transmitter unit 40 may include multiple mobile parts each of which may be arranged to independently move between its on- and off-positions and to include at least one switch 41 thereon. For example and as shown in FIG. 1C, such a transmitter unit 40 may include a left transmitter unit 40L on which a left switch 41L is disposed and a right transmitter unit 40R on which a right switch 41R is disposed. This embodiment offers the benefit of allowing the user to select one of the switches 41L, 41R and to expose or hide such when needed.

In operation, the user may directly lock and unlock the door of the vehicle by directly inserting the key unit 30 into the lock assembly of the door regardless of whether the transmitter unit 40 is in its on- or off-position. When the user wants to remotely lock and unlock the lock assembly of the vehicle door and/or to remotely perform other functions provided to the transmitter unit 40, the user translates, rotates, and/or pivots the transmitter unit 40 from the off-position to the on-position, thereby exposing or extending the substantial portion of the switch 41 out of the cavity. The user applies the user input to the extended (or exposed) portion of the switch 41 by moving (e.g., translating, rotating, swiveling, pivoting, tilting, pressing, and so on) or touching such, thereby actuating (or activating) the transmitter to transmit the output signal. Upon completing the operations, the user then retracts the non-negligible portion of the switch 41 by moving (e.g., translating, rotating, swiveling, pivoting, tilting, pressing, and the like) or touching the transmitter unit 40 from its on-position to its off-position, thereby disposing the non-negligible (or substantial) portion of the switch 41 inside the cavity and/or covering or hiding such a portion by or under the body 20. Accordingly, the key assembly 11 not only maintains the reduced length and/or width when the transmitter unit 40 is moved back to its off-position, but also blocks the user from accidentally or unintentionally actuating (or activating) the transmitter unit 40 while using the key unit 30 to turn on or off an engine of the vehicle.

FIGS. 1G and 1H represent schematic diagrams of exemplary key assemblies including mobile transmitter units arranged to move through cavities of the body and to expose their switches through auxiliary openings of the body. Similar to those shown in FIGS. 1A to 1F, an exemplary key assembly 11 includes the body 20 which defines an auxiliary opening 21 in addition to the cavity similar to those of FIGS. 1A to 1F. More particularly, the transmitter unit 40 and opening 21 are arranged such that the substantial portion of the switch 41 may be exposed through the opening 21 of the body 20 when the transmitter unit 40 is in (or moves to) the on-position, while the non-negligible portion of the switch 41 is covered by the body 20 when the transmitter unit 40 is in (or moves to) the off-position. Similar to the embodiment of FIG. 1C, the key assembly of FIG. 1H may include multiple transmitter units 40L, 40R each of which may include a separate switch 41L, 41R thereon and move independently of the other.

In operation, the user may directly lock and unlock the door of the vehicle by directly inserting the key unit 30 into the lock assembly of the door. When the user wants to remotely lock and unlock the lock assembly of the vehicle door and/or to remotely perform other functions of the transmitter unit 40, the user translates, rotates or pivots the transmitter unit 40 from the off-position to the on-position until the substantial portion of the switch 41 is exposed through the opening 21. The user then applies the user input to the exposed switch 41 by moving or touching such, which actuates or activates the transmitter to send out the output signal. Upon completion of the operations, the user retracts the non-negligible portion of the switch 41 by, e.g., translating, rotating or pivoting the transmitter unit 40 from its on-position to its off-position, thereby covering or hiding the non-negligible (or substantial) portion of the switch 41 under the body 20. Accordingly, the key assembly 11 not only maintains the reduced length and/or width when the transmitter unit 40 is moved back to its off-position, but also blocks the user from accidentally or unintentionally actuate or activate the transmitter unit 40 while using the key unit 30 to turn on or off an engine of the vehicle.

FIG. 1I depicts a schematic diagram of an exemplary key assembly having a mobile transmitter unit but maintaining either the same length or width in different positions. The exemplary key assembly 11 includes the body 20 with a guide 23A along which the mobile transmitter unit 40 moves between its on- and off-positions. When desirable, the body 20 may also form a cavity shaped and/or sized to receive the transmitter unit 40 and to allow translation or rotation of the transmit unit 40 therethrough. When the transmitter unit 40 includes multiple switches 41, the guide 23A and body 20 may be spaced so that multiple switches 41 are respectively exposed and hidden in its on- and off-positions. Such a guide 23A and body 20 may also be arranged so that at least a portion of the transmitter unit 40 may be extended beyond the body 20 in its on- and off-positions as shown in the figure or, alternatively, an entire portion of the transmitter unit 40 may be confined within the width and/or length of the body. Because the transmitter unit 40 affects only one of the length and width of the key assembly 11, such an assembly 11 may maintain either the same length or width between the on- and off-positions of the transmitter unit 40. Operational characteristics of the key assembly 11 are typically similar to those of the foregoing key assemblies of FIGS. 1A to 1J.

FIG. 1J shows a schematic diagram of an exemplary key assembly having a mobile transmitter unit arranged to alternately expose different switches in different positions. Such an exemplary key assembly 11 includes the body 20 defining various guides 23B, 23C along which the mobile transmitter unit 40 moves between its on-position and off-position. When desirable, the body 20 may also form a cavity shaped and/or sized to receive the transmitter unit 40 therein and to allow translation or rotation of the transmit unit 40 therethrough. When the transmitter unit 40 has multiple switches 41, the guides 23B, 23C and body 20 may be arranged such that each switch 41 is alternately exposed and hidden in each of its on- and off-positions, respectively. The guides 23B, 23C and body 20 may be arranged such that at least a portion of the transmitter unit 40 is extended beyond the body 20 in its on- and off-positions or an entire portion of the transmitter unit 40 may be disposed within the width and/or length of the body as shown in the figure. Because the transmitter unit 40 affects only one of the length and width of the key assembly 11, such an assembly 11 can also maintain either the same length or width between the on- and off-positions of the transmitter unit 40. Operational characteristics of such a key assembly 11 are typically similar to those of the foregoing key assemblies of FIGS. 1A to 1J.

FIG. 1K shows a schematic diagram of an exemplary key assembly including a transmitter unit movably disposed alongside or under the body. An exemplary key assembly 11 includes the body 20 and a mobile transmitter unit 40 arranged to move between its on-position and off-position along, over, alongside or across at least one surface of the body 20. More particularly, the transmitter unit 40 may be arranged to move or slide over the surface of the body 20 to expose the substantial portion of the switch 41 in its on-position and then to cover or hide the non-negligible portion of the switch 41 under, below, behind or by the body 20 in its off-position. It is noted that, unlike the foregoing embodiments, the key assembly 11 of FIG. 1K does not require any internal cavity in the body 20. Depending on the configuration of the body 20, the transmitter unit 40 may be arranged to move or slide along the length and/or width of the body 20. In the alternative, the transmitter unit 40 may also be arranged to pivot or rotate between the on- and off-positions over, along, alongside or across the surface of the body 20. Operational characteristics of such a key assembly of FIG. 1K are similar to those of the foregoing key assemblies of FIGS. 1A to 1J.

FIG. 1L shows a schematic diagram of an exemplary key assembly including a transmitter unit movably disposed and confined inside the body. A typical key assembly 11 includes the body 20 with an internal cavity and at least one opening 21. A mobile transmitter unit 40 is arranged to be disposed inside the cavity and to move between its on-position and off-position while being retained inside such a cavity. The transmitter unit 40 and opening 21 are arranged such that the substantial portion of the switch 41 is exposed through the opening 21 in the on-position, while the non-negligible portion of the switch 41 is hidden or covered by (or under) the body 21 in the off-position. Because the transmitter unit 40 is always confined inside the cavity of the body 20, such a key assembly 11 may maintain the same length and width throughout the movement of the transmitter unit 40.

Configurational or operational variations/modifications of the exemplary embodiments of FIGS. 1A to 1L also fall within the scope of this invention. For example, the transmitter unit may be arranged to translate, rotate, pivot, flip, and/or otherwise move between its on- and off-positions along various curvilinear paths or trajectories. Regardless of details of the movements, the transmitter unit generally reciprocates along the same path, i.e., moving from the off- to on-position along a curvilinear path in a first direction, and along the same path from its on- to off-position along a second direction which may be opposite to the first direction. Such a transmitter unit may be arranged to move along a cyclic path, i.e., moving from its off- to on-position from a first location to a second location along a first curvilinear path along a first direction, and moving from its on- to off-position from the second location to the first location along a second curvilinear path which is different from the first path and in a second direction which may also be different from the first direction. The transmitter unit may also move between the off- and on-positions starting from and/or terminating in different locations. Various curvilinear guides and/or axes of rotations may be incorporated into the key assembly to facilitate various movements of the transmitter unit.

The transmitter unit and switch(es) may be disposed in various locations of the key assembly other than those exemplified in FIGS. 1A to 1L. For example, the transmitter unit may be disposed in a proximal portion of the body or on an end opposite to the key unit such that the transmitter unit may be exposed or extended away from the proximal end of the assembly in its on-position. The transmitter unit may be disposed along a middle part of the body and, when desirable, on a top surface 25T, on a bottom surface 25B or along a side 25S of the body. Exact disposition of the transmitter unit, paths or trajectories of its movement, its shape, and/or its size may depend upon various factors such as, e.g., a desirable dimension of the key assembly, a total number of switches included in the transmitter unit, a total number of operations to be performed by the transmitter unit or other spatial considerations.

The key assembly may include various mechanisms arranged to drive, stop, and/or release the transmitter unit from one of its on- and off-positions to the other. For example, the transmitter unit may include a handle with which the user may manually move the transmitter unit. The transmitter unit may also include a recoil mechanism such as, e.g., a mechanical spring or coil, which may store at least a portion of a mechanical energy applied to the transmitter unit by the user while moving the transmitter unit from one position to the other and then to utilize the stored energy to return the transmitter unit to its original position. In particular, the recoil mechanism may include a button as indicated by a numeral 51 in FIGS. 1A to 1L which may be pushed, touched or otherwise selected so as to release the stored energy. When the transmitter unit is arranged to alternately or cyclically move between the on- and off-positions, conventional toggle mechanisms may be employed so that application of the identical or similar user input may reciprocate the transmitter unit between its on- and off-positions. Conventional stopping mechanisms may also be employed along the movement path of the transmitter unit to confine the movements of the transmitter unit to certain locations or within preset distances.

The transmitter unit may include multiple mobile parts each of which or at least some of which may have at least one switch and/or transmitter therein. Such mobile parts are generally arranged to translate or rotate between its own on- and off-positions independently of the others so that the user may selectively move a specific mobile part from its off- to on-position and expose only the desirable switch to perform a desired operation. Each mobile part may also be arranged to move according to any of the foregoing embodiments and, therefore, the mobile parts of the transmitter unit may move or translate along different paths in different directions when desirable. The transmitter unit with a single mobile part or each of such multiple mobile parts of the transmitter unit may also be arranged to have multiple on-positions and/or off-positions. This embodiment offers the benefit of exposing, extending, covering or hiding varying portions of a switch between its completely-off-position and its completely-on-position. Conventional stopping mechanisms may be incorporated to the transmitter to confine the movement of the transmitter unit to certain locations (or within a preset range) or to facilitate the user to recognize each on- and off-positions and to dispose or move the transmitter or switch in or to such a desired on- or off-position.

The transmitter unit may be constructed to have different configurations or movement patterns. In one embodiment, the transmitter unit may be arranged to move away from the key unit and/or body from its off- to on-position as exemplified in FIGS. 1A to 1C and 1K or to move between opposing ends of the body or its cavity as exemplified in FIGS. 1G, 1H, and 1L. Alternatively, the transmitter unit may be arranged to rotate or to pivot about various axes of rotation as exemplified in FIGS. 1D, 1E, and 1F. Other embodiments are also possible, e.g., the transmitter unit may move toward the key unit or body from its off- to on-position, may pivot about or translate along a location(s) of the body, and the like. In accordance with the foregoing movements of the transmitter unit, the switch(es) may be exposed out of (or from) the body or its cavity when the transmitter unit moves from its off- to on-position, through the auxiliary openings of the body when the transmitter unit moves the same, between or beyond the guides as the transmitter unit moves the same, and so on. As discussed above, when the transmitter unit includes multiple switches, at least substantial portions of all of such switches may be exposed in the on-position or, in the alternative, such portions of some but not all switches may also be exposed in the on-position. In the latter embodiment, the switches may be arranged to be alternately exposed as the transmitter moves between its on- and off-positions or between its multiple on-positions so that the user may expose only the switch he or she wants to activate. Regardless of the number of such mobile parts, the transmitter may further be arranged to expose merely a portion or an entire portion of the switch in its on-position and/or to cover (or hide) an entire portion or only a portion of the switch in its off-position, thereby exposing a small portion of the switch in its off-position. In addition, when the transmitter unit includes multiple mobile parts therein and, therefore, multiple switches thereon, at least one or all switches may be entirely or partially exposed in the on-position. When the transmitter unit is arranged to alternately expose such switches, at least one or more switches may also be covered or hidden in the on-position and at least one or more switches may be exposed in the off-position.

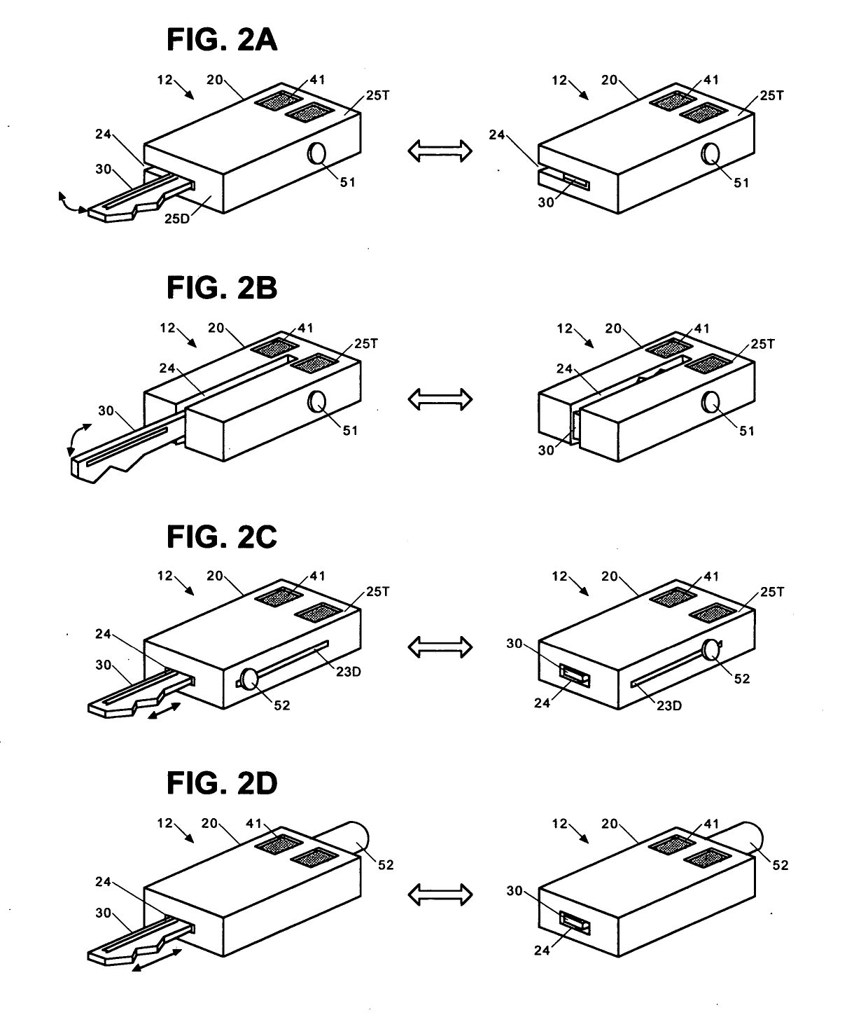

In another aspect of the present invention and as exemplified in FIGS. 2A to 2D, exemplary key assemblies may incorporate various mobile key units arranged to move between off-positions and on-positions. Such an exemplary key assembly 12 may include a body 20, at least one key unit 30, and at least one transmitter unit 40. The body 20 constitutes a main component of the key assembly 12. The mobile key unit 30 has a preset shape, e.g., protrusions and indentations provided therealong in preset arrangements so as to directly and/or manually lock and unlock a lock assembly of a vehicle. The key unit 30 is movably coupled to the body 20, e.g., to a distal end 25D of the body 20, and the transmitter unit 40 is fixedly coupled to the body 20. Thus, the key unit 30 is arranged to move between at least one on-position and at least one off-position thereof with respect to at least a portion of the body 20 and/or the transmitter unit 40. The transmitter unit 40 also includes at least one switch 41 and at least one transmitter similar to those described in FIGS. 1A to 1L. The key unit 30 is preferably constructed so that at least a substantial portion thereof may be exposed out of the body 20 in the on-position and readily inserted into a lock assembly of the door, whereas at least a non-negligible portion thereof may be covered by, hidden inside or blocked by the body 20 in the off-position so that the key assembly 12 has a shorter length and/or width when the key unit 30 is in its off-position than in its on-position. The key assemblies 12 of such an aspect of the present invention may be provided according to various embodiments.

FIGS. 2A to 2B are schematic diagrams of exemplary key assemblies having a variety of mobile key units arranged to rotate or pivot between off-positions and on-positions according to the present invention, where the figures on the left-side describe the mobile key units disposed in the on-positions and those on the left-side display such key units disposed in the off-positions. For example, the body 20 of the key assembly 12 defines a receptacle 24 generally shaped and/or sized to receive the non-negligible portion of the key unit 30 therein in order to allow rotational or pivoting movement of the key unit 30 around an axes of rotation (not shown in the figure) therethrough. The receptacle 24 may be defined parallel (FIG. 2A) or perpendicular (FIG. 2B) to a top surface 25T of the body 20. In particular, the key unit 30 and receptacle 24 are arranged such that the substantial portion of the key unit 30 may be exposed out of the receptacle 24 when the key unit 30 is in its on-position, while the non-negligible portion of the key unit 30 is disposed inside or covered by the receptacle 24 when the key unit 30 is in its off-position.

FIGS. 2C to 2D display schematic diagrams of exemplary key assemblies including a variety of mobile key units arranged to translate between their off-positions and on-positions according to this invention, where the figures on the left-side describe the mobile key units disposed in the on-positions and those on the left-side display such key units disposed in the off-positions. For example, the body 20 of the key assembly 12 defines a receptacle 24 generally shaped and/or sized to receive the non-negligible portion of the key unit 30 therein in order to allow linear or translational movement of the key unit 30 therethrough. More particularly, the key unit 30 and receptacle 24 are arranged to expose the substantial portion of the key unit 30 out of the receptacle 24 when the key unit 30 is in its on-position, while the non-negligible portion of the key unit 30 is disposed inside or covered by the receptacle 24 when the key unit 30 is in its off-position.

Configurational or operational variations/modifications of the exemplary embodiments of FIGS. 2A to 2D also fall within the scope of the present invention. First of all, the key unit may be arranged to translate, rotate, pivot, flip, and/or otherwise move between its on- and off-positions along various curvilinear paths. Regardless of details of the movements, the key unit generally reciprocates along the same path, i.e., moving from the off- to on-position along a curvilinear path in a first direction, and along the same path from its on- to off-position along a second direction which is opposite to the first direction. The key unit may also be arranged to move along a cyclic path, i.e., moving from its off- to on-position from a first location to a second location along a first curvilinear path along a first direction, and thereafter moving from its on- to off-position from the second location to the first location along a second curvilinear path which may be different from the first path and along a second direction which may also be different from the first direction. When desirable, the key unit may move between the off- and on-positions starting from and/or terminating in different locations of the body. Various curvilinear guides and/or axes of rotations may further be incorporated into the key assembly to facilitate various movements of the key unit.

The key unit may further be disposed in various locations of the key assembly other than those exemplified in FIGS. 2A through 2D. For example, the key unit may be incorporated into a distal portion of the body or on an end opposite to the transmitter unit such that the key unit is exposed or extended away from the distal end of the assembly in its on-position. The key unit may also be disposed along a middle part of the body and, when desirable, on a top or bottom surface or side of the body. Exact location of the key unit, its movement path, shape, and/or size may depend upon various factors and may be readily determined by those skilled in the relevant art.

The key assembly may include various mechanisms arranged to drive, stop, and/or release the key unit from one of its on- and off-positions to the other. Similar to the mobile transmitter unit of FIGS. 1A to 1L, the mobile key unit may have a handle as indicated by a numeral 52 in FIGS. 2C and 2D with which the user may manually move the key unit between the positions. The key unit may incorporate a recoil mechanism such as, e.g., a spring or a coil, arranged to store at least a portion of mechanical energy applied to such a unit by the user while moving such from one position to the other and then to utilize the stored energy to return the key unit to its original position. The recoil mechanism may further include the button as indicated by a numeral 51 in FIGS. 2A and 2B which may be pushed, touched or otherwise selected by the user to release the stored energy. When it is desirable to move the key unit alternately or cyclically between its on- and off-positions, conventional toggle mechanisms, switches or buttons may be employed such that application of the identical or similar user input may reciprocate the key unit between its on- and off-positions. Conventional stopping mechanisms may be employed along the movement path of the key unit to confine the movements of such a unit to certain locations and/or within preset distances.

The receptacle may be defined in various locations on (or around) the body. As exemplified in FIGS. 2A and 2B, the receptacle may be defined between two opposing surfaces or ends of the body and across at least two adjoining surfaces of the body to form an internal space to accommodate the rotational or pivoting movement of the key unit such as, e.g., across a distal end 25D and a side of the body as shown in FIG. 2A or across the distal end 25D and a top surface 25T (and an optional bottom surface) as shown in FIG. 28. The receptacle may also be defined between two opposing surfaces and across a single surface or end of the body so as to form another internal space to accommodate the linear or translational movement of the key unit such as, e.g., across the distal end 25D as in FIGS. 2C and 2D. Accordingly, the receptacles may have various dimensions depending upon the patterns of movements of the mobile key unit. For example, the receptacles of FIGS. 2A and 2B are required to be at least substantially longer (and/or wider) than the exposed portion of the key unit, whereas those of FIGS. 2C and 2D are similar or slightly longer or wider than the exposed portion of such a unit. The key unit may be arranged to rotate or pivot about an axis of rotation which is perpendicular or parallel to a length, a width or height, and/or a thickness of the key unit. The receptacle may then have to be shaped and sized so as to accommodate such movements. In the alternative, the receptacle may be formed as an indentation on a surface or end of the body so that the key unit may be disposed in the indentation while exposing one side thereof.

The receptacle and mobile key unit may be arranged so that only a portion or an entire portion of the key unit may be exposed or hidden in the on- and off-position, respectively. In addition, the key unit may be arranged to move between a single off-position and multiple on-positions in each of which a different portion of the key unit may be exposed out of the receptacle.

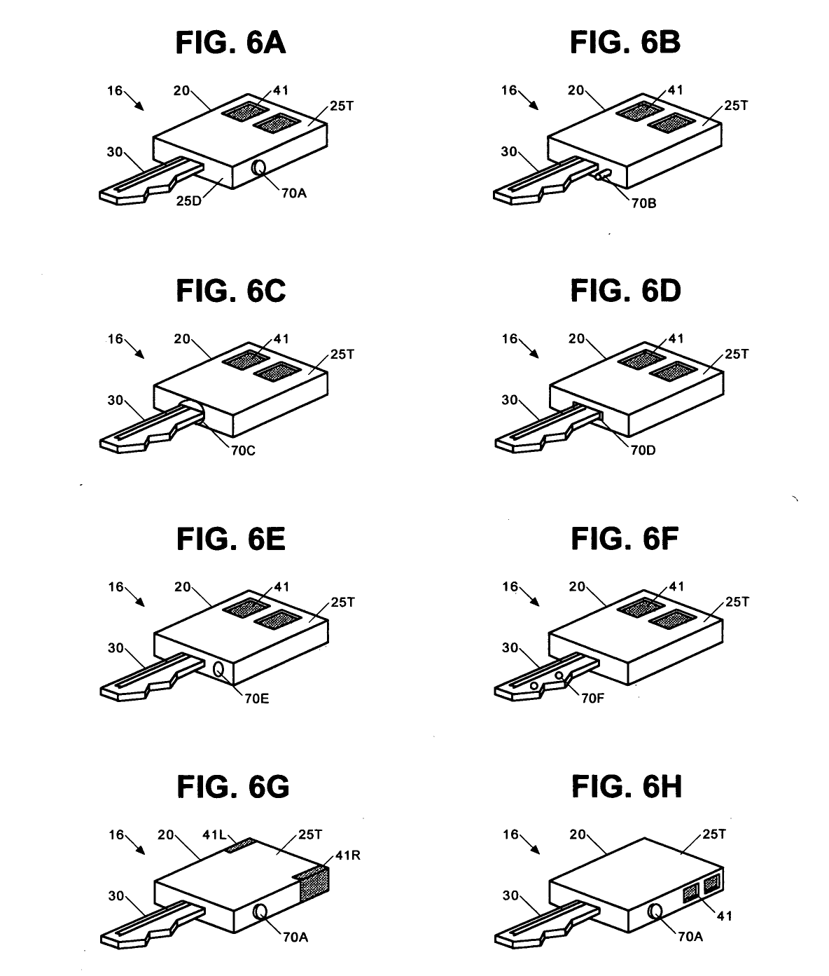

The mobile key unit may further be operatively coupled to the transmitter unit such that the key unit may disable the transmitter unit as the key unit begins to move from its off-position to on-position and/or while the key unit is in its on-position. Thereafter, the key unit may activate the transmitter unit as the key unit begins to move from its on-position to off-position, as the key unit approaches its off-position, and/or while the key unit is in its off-position. The key unit may disable the transmitter unit by different mechanisms. In one embodiment, the key unit may be arranged to prevent the switch of the transmitter unit from properly receiving the user input by mechanically or electrically blocking access of the user to the switch and/or by mechanically blocking movement of the switch from its off- to on-position. In another embodiment, the key unit may be arranged to mechanically or electrically block the switch from delivering an activating signal to the transmitter unit such that the transmitter unit may not be activated even when the switch normally receives the user input. In another embodiment, the key unit may be arranged to mechanically or electrically prevent the transmitter from generating or sending out the output signal such that the transmitter may not transmit the output signal even when the other parts of the transmitter unit may be activated. Further embodiments of such disabling mechanisms are provided in conjunction with FIGS. 6A through 6H.

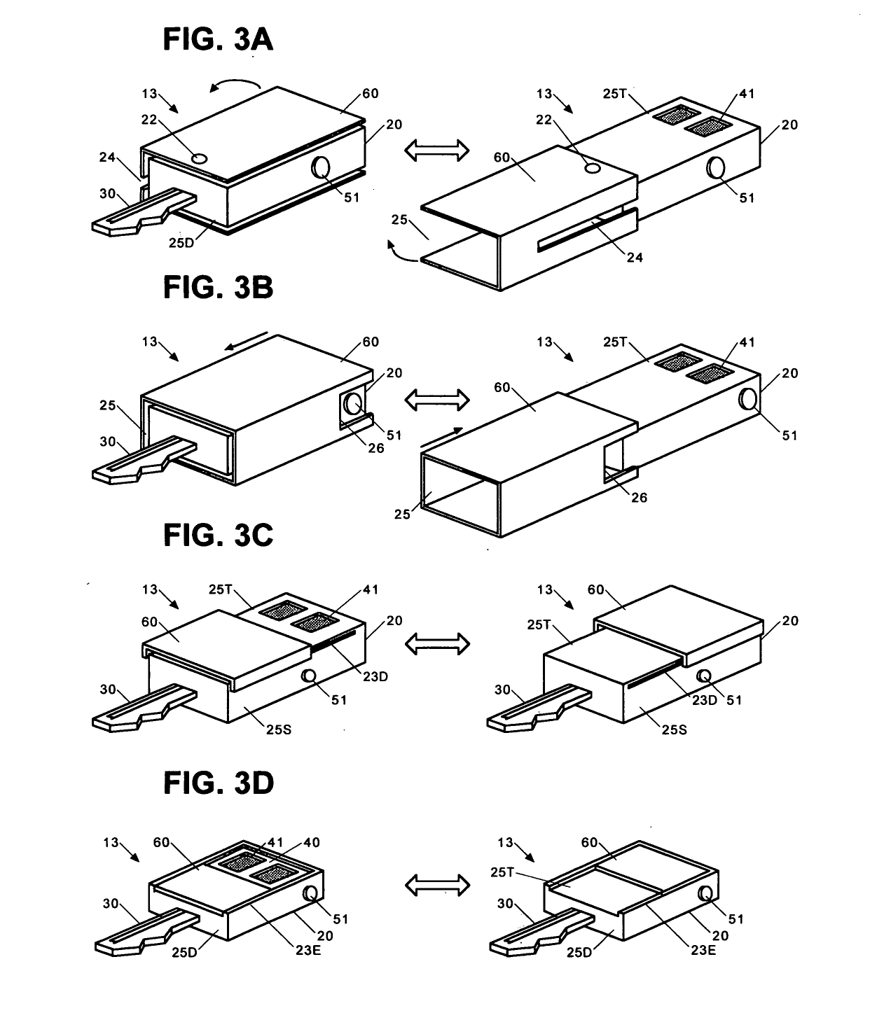

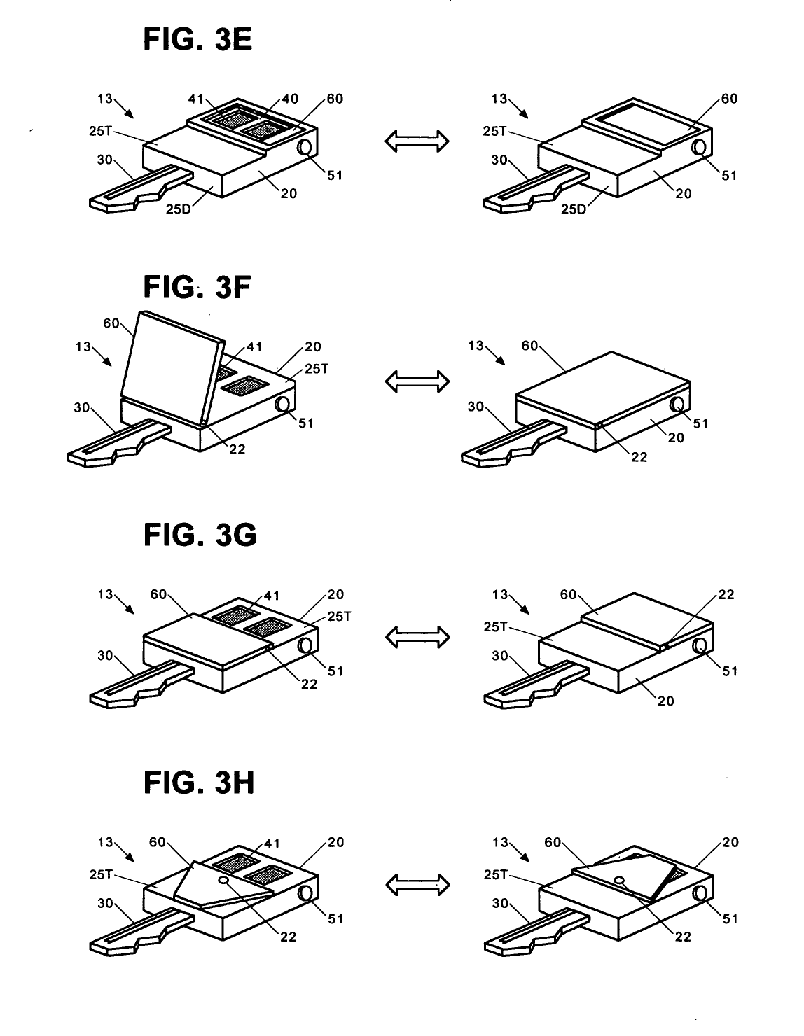

In another aspect of the present invention and as exemplified in FIGS. 3A to 3H, exemplary key assemblies may incorporate various mobile covers arranged to move between off-positions and on-positions. An exemplary key assembly 13 may include a body 20, at least one key unit 30 and at least one transmitter unit 40 both identical or similar to those described in conjunction with FIGS. 1A through 1L or FIGS. 2A through 2D, and at least one cover 60 movably coupled to one of the body 20, key unit 30, and transmitter unit 40. In the exemplary embodiments of this aspect of the present invention, the key unit 30 is fixedly coupled to the body 20, e.g., to a distal end 25D thereof the body 20, while the transmitter unit 40 is fixedly coupled to an opposite end of the body 20, e.g., to a proximal end thereof. The mobile cover 60 is generally arranged to move between at least one on-position and at least one off-position so that at least a substantial portion of a switch 41 of the transmitter unit may be exposed as the cover 60 moves to (or is in) its on-position, while at least a non-negligible portion of the switch 41 may be covered by or (hidden under or by) the cover 60 when the cover 60 moves to (or is in) its off-position. By covering the switch(es) 41 when not in use, the key assemblies 13 of this aspect of the invention offer the benefit of preventing the user from accidentally or unintentionally actuating the switch 41 to transmit the output signal from the transmitter. Because the key and transmitter units 30, 40 are both fixedly coupled to the body, however, the key assemblies 13 generally maintain the same length and width regardless of whether the cover 60 is in its on- or off-position. The key assemblies 13 of such an aspect of the present invention may be provided according to various embodiments.

FIGS. 3A and 3B are schematic diagrams of exemplary key assemblies including mobile covers moving over opposing surfaces of the body between their off-positions and on-positions according to this invention. In the embodiment of FIG. 3A, the cover 60 is disposed over a top surface and a bottom surface of the body 20 and rotates about an axis of rotation 22 provided across such surfaces such that the cover 60 covers a substantial (or entire) portion of the switches 41 in its off-position and then exposes the substantial portion of the switches 41 in its on-position. Such a cover 60 may include a side portion which connects a top portion and a bottom thereof and forms a receptacle 24 therealong such that the cover 60 may traverse the key unit while it rotates between its on- and off-positions. In the alternative and as depicted in FIG. 3B, such a cover 60 may be similarly disposed over the top and bottom surfaces of the body 20 and arranged to translate along a length of the key assembly 13 such that the cover 60 covers a substantial (or entire) portion of the switches 41 in its off-position and then exposes the substantial portion of the switches 41 in its on-position. The cover 60 typically defines a cavity to cover the key unit 30 in its off-position.

FIGS. 3C to 3E show schematic diagrams of exemplary key assemblies including mobile covers translating or sliding over a surface of the body between their off- and on-positions according to this invention. As shown in the figures, the cover 60 needs to be movably disposed over a surface of the body 20 on which at least one switch 41 is disposed so that it may uncover and/or cover the switch 41 in its on- and off-positions, respectively. For this purpose, the cover 60 has to move along a path or trajectory traversing the substantial portion of the switch 41. Thus, the cover 60 may be provided in various arrangements depending upon various factors such as, e.g., a location of the switch 41, a shape and/or size of the switch 41, dimensions of the surface of the body 20 on which the switch 41 is disposed, a movement trajectory of the cover 60, and the like. For example, the cover 60 of FIG. 3E translates or reciprocates over a top surface 25T of the body 20 along a pair of guides 23D provided on top portions of sides 25S of the body 20, whereas the cover 60 shown in FIG. 3D similarly moves over the top surface 25T along a pair of guides 23E provided on top edges of the sides 25S. Contrary to such embodiments in which the covers 60 move along a length of the body 20, the cover 60 of FIG. 3E is arranged to translate over the top surface 25T of the body 20 along a width of the body 20 along a pair of guides (not numbered) provided on such a top surface 25T. It is appreciated that the covers 60 of FIGS. 3C and 3D are generally made of a rigid material, while that 60 of FIG. 3E is preferably made of a flexible material or made in a deformable configuration such that it may be flexed or rolled into the body 20 when the cover 60 moves from its on- to off-position.

FIGS. 3F to 3H show schematic diagrams of exemplary key assemblies including mobile covers rotating over or across one surface of the body between their off- and on-positions according to this invention. Similar to those of the foregoing embodiments, the cover 60 needs to be movably disposed over a surface of the body 20 on which at least one switch 41 is disposed and covers the switch 41 in its off-position. Such a cover 60 may be provided in various arrangements depending upon various factors such as, e.g., a location of the switch 41, a shape and/or size of the switch 41, dimensions of the surface of the body 20 on which the switch 41 is disposed, a movement path or trajectory of the cover 60, a location of an axis 22 of rotation, and the like. For example, the cover 60 of FIG. 3E pivots about the axis 22 of rotation disposed near a distal end of a top surface 25T and, therefore, the cover 60 has to have a length which is substantially similar to or slightly less than that of the body 20. The covers 60 of FIGS. 3F and 3G, however, rotate about axes 22 of rotation disposed in a mid-portion of the top surface 25T and, therefore, has a length approximately about a half of that of the body 20. As shown in FIGS. 3F to 3H, the cover 60 may have a variety of shapes and/or sizes as long as they can uncover and cover the substantial portion of the switch 41 in their on- and off-positions, respectively.

In operating various key assemblies 13 of FIGS. 3A to 3H, the user may directly lock and unlock the door of the vehicle by directly and manually inserting the key unit 30 into the lock assembly of the door. When the user wants to remotely lock and unlock the lock assembly of the vehicle door and/or to remotely perform other functions of the transmitter unit 40, the user translates, rotates or pivots the mobile cover 60 from its off- to on-position until the substantial portion of the switch 41 is exposed out of the cover 60. The user then applies the user input to the exposed switch 41 by moving or touching such, which then actuates or activates the transmitter to send out the output signal. Upon completing the desired operations, the user similarly moves the cover 60 back to its off-position, thereby covering the non-negligible portion of the switch 41. Accordingly, the key assembly 11 prevent the user from accidentally or unintentionally actuating or activating the transmitter unit 40 while using the key unit 30 to turn on or off an engine of the vehicle.

Configurational or operational variations/modifications of the exemplary embodiments of FIGS. 3A through 3H also fall within the scope of the present invention. For example, various mobile covers may be disposed on any surface of the body as long as the switch of the transmitter unit is disposed on such a surface. As discussed above, the cover may be arranged to translate or rotate over more than one surface of the body, where such a cover is typically made of a bendable or flexible material and/or made in a bendable, foldable, rollable or otherwise flexible configuration.

The key assembly may include various mechanisms arranged to drive, stop, and/or release the cover from one of its on- and off-positions to the other. Similar to those mobile units of FIGS. 1A to 1L and FIGS. 2A to 2D, the mobile cover may have a handle with which the user may manually move the cover between the positions. The cover may incorporate a recoil mechanism such as, e.g., a spring or a coil, arranged to store at least a portion of mechanical energy applied to such a unit by the user while moving such from one position to the other and to utilize the stored energy to return the cover to its original position. The recoil mechanism may further include the button as indicated by a numeral 51 in FIGS. 3A through 3H which may be pushed, touched or otherwise selected by the user to release the stored energy. When it is desirable to move the cover alternately or cyclically between its on- and off-positions, conventional toggle mechanisms, switches or buttons may be used such that application of the user input may reciprocate the cover between its on- and off-positions. Conventional stopping mechanisms may be employed along the movement path of the cover to confine the movements of the cover to certain locations and/or within preset distances.

Such mobile cover may be arranged to translate or rotate along various trajectories in various directions. For example, the cover may be arranged to translate or to slide away from one or more of the key unit, transmitter unit, and/or body from its off- to on-position (or vice versa) or, alternatively, to translate or slide between opposing ends of the body between such positions, where the direction of such a movement may be in the direction of, e.g., a length, a width, a diagonal, an edge, and/or other curvilinear lines defined in the body. In addition, the cover may be arranged to rotate or pivot about a location of the body such as, e.g., various axis of rotation between its positions, where the direction of such a movement may be in the direction parallel to, perpendicular to or at a preset angle to any of the surfaces or edges of the body. Various curvilinear guides may also be incorporated to facilitate or assist such translational or rotational movements of the mobile cover. When desirable, the cover may include at least one opening through which the switch may be exposed.

The above cover may be arranged to cover only a portion or an entire portion of the switch in its off-position and to uncover only a portion or an entire portion of the switch in its on-position. Such a cover may include multiple mobile parts each of which may move independently so as to cover and uncover different portions of a switch or different switches in their individual off- and on-positions. In addition, the cover may be arranged to have multiple on- and/or off-positions to cover and uncover the different portions of the switch as well.

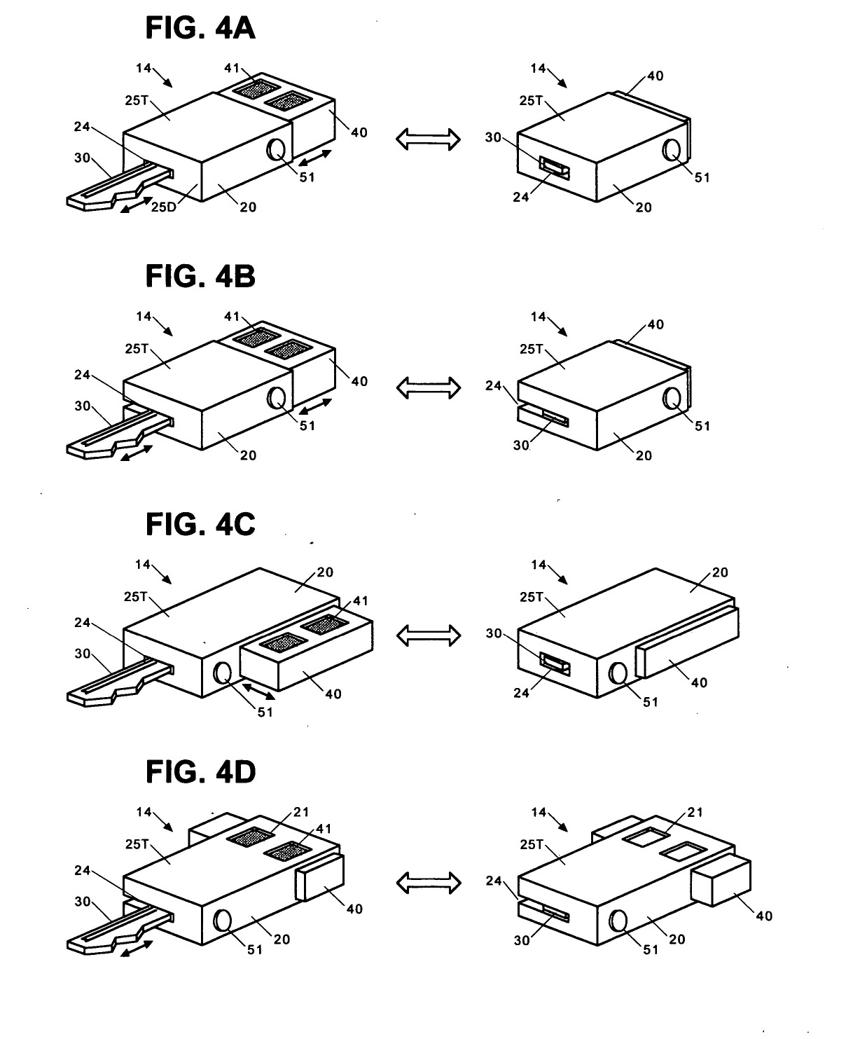

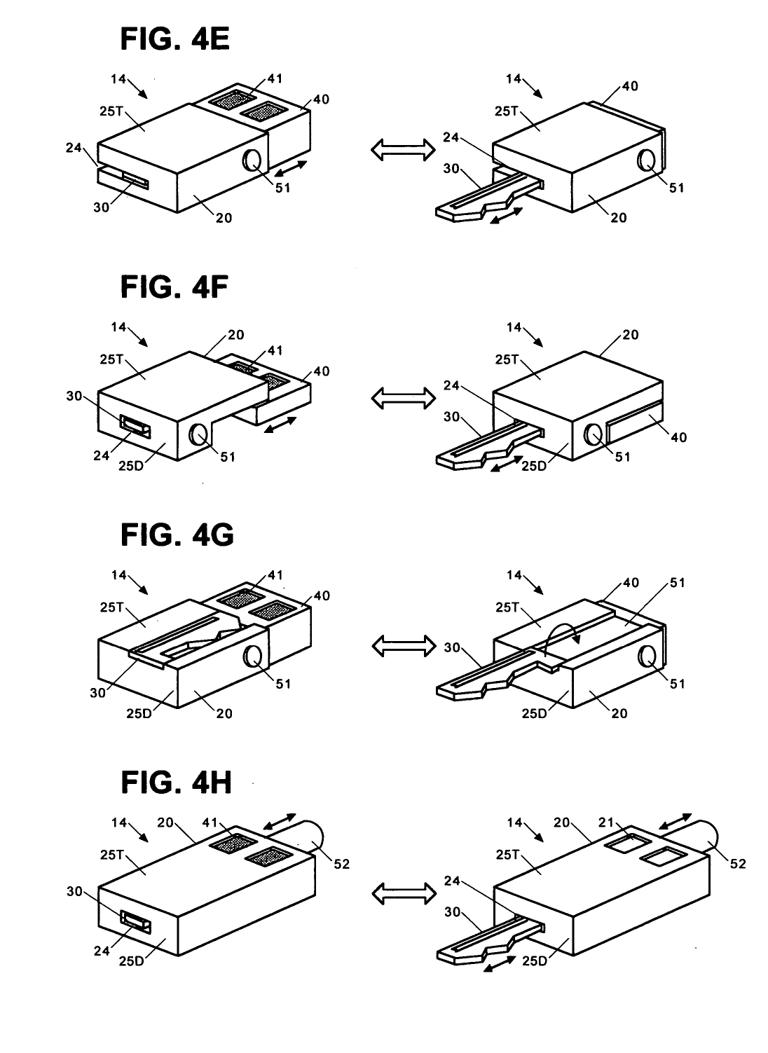

In another aspect of the present invention and as exemplified in FIGS. 4A to 4H, exemplary key assemblies may include various mobile key units as well as mobile transmitter units arranged to move between their own off- and on-positions. An exemplary key assembly 14 includes a body 20, at least one mobile key unit 30 identical or similar to those described in conjunction with FIGS. 2A to 2D, and at least one transmitter unit 40 also identical or similar to those disclosed in conjunction with FIGS. 1A to 1L. Therefore, the key unit 30 is arranged to move between at least one on-position and at least one off-position thereof with respect to at least a portion of the body 20, and the transmitter unit 40 is also arranged to move between at least one on-position and at least one off-position. The key unit 30 may be arranged to expose at least a substantial portion thereof out of the body 20 in the on-position and readily inserted into a lock assembly of the door, whereas at least a non-negligible portion thereof may be covered by, hidden inside or blocked by the body 20 in the off-position so that the key assembly 14 has a shorter length and/or width when the key unit 30 is in its off-position than in its on-position. The transmitter unit 40 may similarly be arranged to expose at least a substantial portion thereof out of the body 20 in the on-position and to readily receive an user input, while at least a non-negligible portion thereof may be covered by, hidden inside or blocked by the body 20 in the off-position so that the key assembly 14 has a shorter length and/or width when the transmitter unit 40 is in its off-position than in its on-position. The key assemblies 14 of such an aspect of this invention may be provided according to various embodiments.

FIGS. 4A to 4D depict schematic diagrams of exemplary key assemblies including at least one mobile key unit and at least one mobile transmitter unit each arranged to move independently from the other between its own off-position and on-position according to the present invention. For example, the embodiment of FIG. 4A is a combination of the mobile key unit 30 of FIG. 2C (or 2D) and the mobile transmitter unit 40 of FIG. 1A, whereas the embodiment of FIG. 4B is a combination of the mobile key unit 30 of FIG. 2A and the mobile transmitter unit 40 of FIG. 1A. Similarly, the embodiment of FIG. 4C is a combination of the mobile key unit 30 of FIG. 2C (or 2D) and the mobile transmitter unit 40 of FIG. 1B, while the embodiment of FIG. 4D is a combination of the mobile key unit 30 of FIG. 2A and the mobile transmitter unit 40 shown in FIG. 11. It is appreciated that the mobile key unit 30 and mobile transmitter unit 40 of such embodiments translate or rotate independently of the other such that both units may be moved to and kept in their on-positions or off-positions simultaneously. In the alternative, one unit may be moved to and kept in its on-position and, at the same time, the other unit may be moved to and kept in its off-position. Such key assemblies 14 may also be provided by combining other aforementioned mobile key units (or their configurational variations or modifications) with other aforementioned mobile transmitter units (or their configurational variations or modifications) and then arranging the selected mobile key and transmitter units to move independently of each other.

In operation, the user may directly lock and unlock the door of the vehicle by directly inserting the key unit 30 into the lock assembly of the door regardless of whether the transmitter unit 40 is in its on- or off-position. When the user wants to remotely lock and unlock the lock assembly of the vehicle door and/or to remotely perform other functions provided to the transmitter unit 40, the user translates, rotates, and/or pivots the transmitter unit 40 from the off-position to the on-position, thereby exposing or extending the substantial portion of the switch 41 out of the cavity. The user applies the user input to the extended (or exposed) portion of the switch 41 by moving (e.g., translating, rotating, swiveling, pivoting, tilting, pressing, and so on) or touching such, thereby actuating (or activating) the transmitter to transmit the output signal. While manipulating the transmitter unit 40 as such, the user may retract the key unit 30 to its off-position or leave it in its on-position. Upon completing the operations, the user may retract the non-negligible portion of the switch 41 by moving (e.g., translating, rotating, swiveling, pivoting, tilting, pressing, and the like) or touching the transmitter unit 40 from its on-position to its off-position, thereby disposing the non-negligible (or substantial) portion of the switch 41 inside the cavity and/or covering or hiding such a portion by or under the body 20. Therefore, the key assembly 11 not only maintains the shorter length and/or width when the transmitter unit 40 moves to its off-position, but also blocks the user from accidentally or unintentionally actuating (or activating) the transmitter unit 40 while using the key unit 30 to turn on or off an engine of the vehicle.

FIGS. 4E to 4H display schematic diagrams of exemplary key assemblies including at least one mobile transmitter unit and at least one mobile key unit operatively coupled to each other and arranged to alternate their off- and on-positions. It is appreciated that the figures on the left-side depict the key assemblies when their mobile key units are disposed in their off-positions and their mobile transmitter units are disposed in their on-positions, while those on the right-side display the key assemblies when the mobile key units are disposed in their on-positions and their mobile transmitter units are in their off-positions. Contrary to the above embodiments of FIGS. 4A to 4D, the key assemblies 14 of FIGS. 4E to 4H are characterized by operative dependency or, more particularly, spatial and/or temporal coupling of the movements between their mobile key and transmitter units so that one of the mobile units stays in (or moves to) its on-position as the other of such mobile units stays in (or moves to) its off-position (and vice versa). For example, the key assembly 14 of FIG. 4E is a combination of the mobile key unit 30 of FIG. 2A and mobile transmitter unit 40 of FIG. 1A, whereas the key assembly 14 of FIG. 4F is a combination of such a key unit 30 and the mobile transmitter unit 40 of FIG. 1K. In both embodiments, the key and transmitter units 30, 40 are mechanically coupled to each other such that the movement of one unit 30, 40 results in the movement of the other unit 40, 30 in a preset pattern, e.g., simultaneously or sequentially. Therefore, only one of such units 30, 40 is arranged to be in its on-position, whereas the other of such units 30, 40 is arranged to be in its off-position. The key assembly 14 shown in FIG. 4G is a combination of the mobile transmitter unit 40 of FIG. 1K and a key unit 30 arranged to flip away from and to flip toward a top surface 25T of the body 20 in its on- and off-position, respectively. The key and transmitter units 30, 40 are also operatively coupled to each other so that the key unit 30 is in its off-position when the transmitter unit 40 is in its on-position, and the key unit 30 is in its on-position when the transmitter unit 40 is in its off-position. The key assembly 14 of FIG. 4H includes mobile key and transmitter units 30, 40 arranged to alternately move to their on- and off-positions by a handle 52. For example, the handle 52 actuates a conventional toggle switch connected thereby in response to a user input, in which the toggle switch is arranged to expose the substantial portion of the key unit 30 and to retract the non-negligible portion of the switch 41 from an opening 21 responsive to a first user input, and to retract the non-negligible portion of the key unit 30 into a receptacle 24 and to expose the substantial portion of the switch 41 through the opening 21 in response to a next user input.

In operation, when the user wants to manually lock or unlock the door of the vehicle, he or she first applies the user input to expose at least the substantial portion of the key unit 30, e.g., by directly translating or rotating the key unit 30 to its on-position, by translating or moving the transmitter unit 40 to its off-position, by pushing or otherwise activating a release button to release stored energy, and so on. In any case when the key unit 30 moves to its on-position, various coupling mechanisms of the key assembly 14 retract the transmitter unit 40 to its off-position. Thereafter, the user inserts the key unit 30 into the lock assembly of the door of the vehicle, and opens or locks the vehicle door or, in the alternative, turns on an engine of the vehicle. When the user wants to remotely lock or unlock the lock assembly of the vehicle door and/or remotely perform further functions provided to the transmitter unit 40, the user applies a similar or same user input to expose at least a substantial portion of the switch 41 of the transmitter unit 40, e.g., by translating, rotating or otherwise manipulating the transmitter unit 40 to its on-position. When the transmitter unit 40 moves to its on-position, the coupling mechanism of the key assembly 14 retracts the key unit 30 to its off-position. Thereafter, the user applies the same or similar user input to the extended (or exposed portion) of the switch 41 to actuate (or activate) the transmitter to transmit the output signal. Upon completing the intended operations, the user may leave the key and transmitter units 30, 40 in their respective off- and on-positions or may also retract a non-negligible portion of the switch 41 to its off-position while moving the key unit 30 to its on-position and exposing the substantial portion thereby. Accordingly, such a key assembly 14 not only maintains the reduced length and/or width in any position of the key and transmitter units 30, 40, but also blocks the user from accidentally or unintentionally actuating (or activating) the transmitter unit 40 while using the key unit 30 to turn on or off an engine of the vehicle.

Configurational or operational variations/modifications of the exemplary embodiments of FIGS. 4E to 4H also fall within the scope of the present invention. First, the key assemblies may incorporate various conventional coupling mechanisms to spatially and/or temporally synchronize the movements of the mobile key and transmitter units. In particular, temporal coupling mechanisms may mechanically couple one mobile unit to the other mobile unit so that, when the user applies the user input to the first mobile unit and moves the first unit from its off- to on-position (or its on- to off-position), the temporal coupling mechanisms move the second mobile unit from its on- to off-position (or off- to on-position) in response to the movement of the first unit at least substantially simultaneously (or in minimal temporal delay) with the movement of the first unit. Examples of such temporal coupling mechanisms generally include, but not limited to, gear assemblies, belt assemblies, and any conventional mechanical couplers which may directly transfer force or energy applied by the user to one of such mobile units directly to the other unit and which may typically include a spring, force-delivering shaft, and so on. The spatial coupling mechanisms also mechanically couple one mobile unit to the other mobile unit to move such a second mobile unit from its off- to on-position (or its on- to off-position) responsive to the movement of such a first mobile unit from its on- to off-position (or its off- to on-position) actuated by the user input. In contrary, the spatial coupling mechanisms are arranged to provide a non-negligible time lag between the initiation of the movement of the first mobile unit and the onset of the subsequent movement of the second mobile unit so that the second unit may only begin to move upon occurrence of a preset event. Examples of the spatial coupling mechanisms may include, but not be limited to, actuators arranged to be activated after a preset time period, to be activated when one mobile unit travels a preset distance or angle, to be activated upon receiving an user input, and so on. Therefore, moving a first mobile unit triggers the movement of the second mobile unit (regardless of the elapsed time therebetween) when the first unit is moved along a preset distance and/or about a preset angle, when the first unit passes a certain location of the body in which a triggering mechanism is disposed, and the like.

The foregoing coupling mechanisms may further be varied or modified in various embodiments. For example, various recoil mechanisms may be incorporated into the key assemblies so as to store at least a portion of mechanical force or energy applied thereto by the user to move one (or both) of the mobile units from its off- to on-position (or its on- to off-position) and then to release the stored force or energy to move the same (or the other or both) of the mobile units from its on- to off-position (or its off- to on-position). The recoil mechanism may also include a switch (as exemplified by the button 52 in FIGS. 4E to 4G) arranged to release a part or an entire portion of the stored energy upon receiving an user input. Alternatively, such a switch may be disposed along the movement path of one or both of the mobile units such that the movement of so a mobile unit automatically triggers the release of the stored energy, without requiring any separate user input. Incorporation of the recoil mechanisms into the foregoing coupling mechanism provides more design options to synchronize the movements of the mobile key units and mobile transmitter units of the key assembly. For example, the user may release the stored energy of the recoil mechanism to move one mobile unit from its on- to off-position and the other mobile unit from its off- to on-position even without moving any unit. The recoil mechanism may also be arranged to store the energy in an amount enough to move one or both of the mobile units on multiple occasions. For example, the recoil mechanism may be arranged to accumulate the energy of the user input applied to one or both of the mobile units as long as the release switch is not activated by the user. Alternatively, the recoil mechanism may include a manual handle through which the user may deliver and store the energy in such a mechanism. The recoil mechanism may also be arranged to release only a portion of the energy stored therein or, in the alternative, to release the energy in an amount which may be proportional to a period of application of the user input to the release switch, to a distance along which the release switch is displaced, to a force applied to the release switch, and the like. In addition to the foregoing mechanical embodiments, the recoil mechanisms may incorporate magnets in order to utilize repulsive and/or attractive properties thereof. For example, the mobile key and transmitter units may be arranged to include the magnets of the same polarity in proper locations thereof. When the user moves a first mobile unit from its off- to on-position and a second unit from its on- to off-position, the magnets of such mobile units approach each other. By disposing the first and second mobile units in their on- and off-positions, respectively, the mechanical energy applied by the user is converted into potential energy of a repulsive magnetic field of such magnets and stored in the recoil mechanism. When the user activates the release switch thereafter, the repulsive force of such a magnetic field moves the first and second mobile units to their off- and on-positions, respectively. In addition, an electric actuator may be used to move one or both of the mobile units.

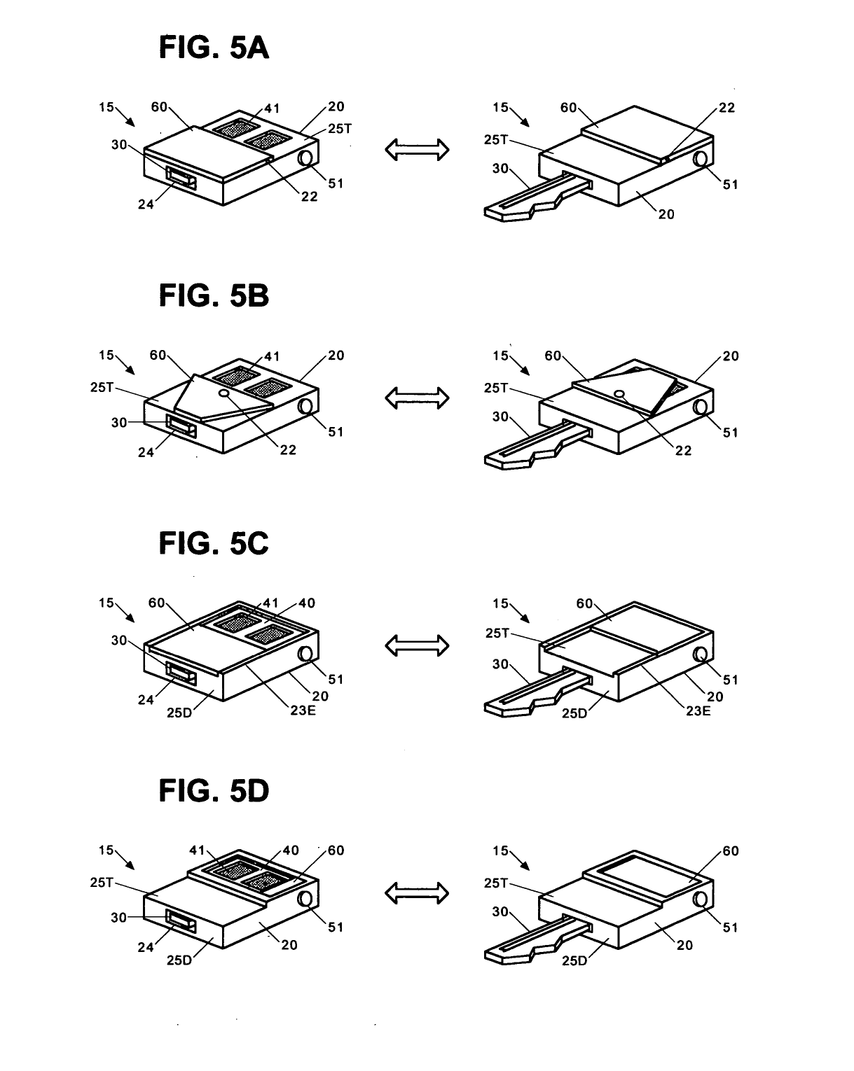

In another aspect of the present invention and as exemplified in FIGS. 5A to 5D, exemplary key assemblies may further include various mobile covers coupled to stationary or mobile key units and/or transmitter units and arranged to move between their own off- and on-positions. An exemplary key assembly 15 may include a body 20, at least one stationary or mobile key unit 30 identical or similar to those described in any of the foregoing figures, at least one transmitter unit 40 identical to or similar to those disclosed in any of the foregoing figures, and at least one mobile cover 60 identical or similar to those described in conjunction with FIGS. 3A to 3H. Thus, the cover 60 is arranged to move between at least one on-position and at least one off-position with respect to at least a portion of the body 20, to expose at least a substantial portion of the key unit 30 or switch 41 of the transmitter unit 40 in its on-position, and to cover at least a non-negligible portion of the key unit 30 or the switch 41 in its off-position. In this respect, the key assembly 15 may be regarded as a combination of any of the above stationary or mobile key unit 30, any of the above stationary or mobile transmitter unit 40, and any of the mobile cover 60 of FIGS. 3A to 3H.

Contrary to such an embodiment, the mobile cover 60 may be operatively coupled to the mobile key unit 30 and/or mobile transmitter unit 40 to temporally and/or spatially synchronize the movements of such a unit(s) with the movement of the cover 60. For example, FIGS. 5A to 5D describe schematic diagrams of exemplary key assemblies including mobile covers operatively coupled to various mobile key and/or transmitter units and moving between off- and on-positions according to this invention. It is appreciated that the figures on the left-side depict the key assemblies when their mobile key units and covers are in their off-positions, while those on the right-side describe such key assemblies when the mobile key units and covers are in their on-positions. It is also appreciated that embodiments of FIGS. 5A to 5D describe various combinations of such covers 60 operatively coupled to various mobile key units 30 and that similar embodiments may also be provided by operatively coupling such covers 60 to various mobile transmitter units 40. The key assemblies 15 of such an aspect of this invention may be provided in various embodiments. For example, such a key assembly 15 of FIG. 5A is a combination of the mobile key unit 30 of FIGS. 2C and 2D, the stationary transmitter unit 40 of FIGS. 2A to 2D, 3A to 3H, and the cover 60 of FIG. 3G, whereas the key assembly 15 of FIG. 5B is a combination of such a key unit 30, such a mobile transmitter unit 40, and the cover 60 of FIG. 3H. In both embodiments, the rotating or pivoting cover 60 is mechanically coupled to the mobile key unit 30 such that the movement of the cover 60 (or key unit 30) gives rise to the movement of the key unit 30 (or cover 60) in a preset arrangement, e.g., simultaneously or sequentially. The key assembly 15 of FIG. 5C is a combination of the mobile key unit 40 shown in FIGS. 5A and 5B, the stationary transmitter unit shown in FIGS. 5A and 5B, and the cover 60 shown in FIG. 3D, while that 15 of FIG. 5D is a combination of such a key unit 40, such a transmitter unit 40, and the cover 60 of FIG. 3E. In both embodiments, the translating or sliding cover 60 is mechanically coupled to the mobile key unit 30 such that the movement of the cover 60 (or key unit 30) gives rise to the movement of the key unit 30 (or cover 60) in a preset arrangement, e.g., simultaneously or sequentially.

In operation, when the user wants to manually lock or unlock the door of the vehicle, he or she first applies the user input to expose at least the substantial portion of the key unit 30, e.g., by directly translating or rotating the key unit 30 to its on-position, by translating or rotating the cover 60 to its on-position, and/or by pushing or otherwise activating a release button to release stored energy. In one embodiment, the user moves the cover 60 to its on-position and covers (or hides) the switch 41 of the transmitter unit 40, which then actuates various coupling mechanisms of the key assembly 15 to move the key unit 30 to its on-position. In another embodiment, the user may move the key unit 30 to its on-position, which in turn activates the coupling mechanisms to move the cover 60 to its on-position and covers such a switch 41. Thereafter, the user may insert the key unit 30 into the lock assembly of the door of the vehicle, and opens or locks the vehicle door or, in the alternative, turns on an engine of the vehicle. When the user wants to remotely lock or unlock the lock assembly of the vehicle door and/or remotely perform other functions provided to the transmitter unit 40, the user applies a similar or same user input and exposes at least a substantial portion of the switch 41 of the mobile transmitter unit 40, e.g., by directly translating, rotating or otherwise manipulating the transmitter unit 40 to its on-position, by translating or rotating the cover 60 to its off-position, and/or by pushing or otherwise activating the release button to release stored energy. In one embodiment, the user moves the cover 60 to its off-position and uncovers the switch 41, which may in turn actuate various coupling mechanisms of the key assembly 15 to move the key unit 30 to its off-position. In another embodiment, the user moves the key unit 30 to its off-position, which in turn activates the coupling mechanisms to move the cover 60 to its off-position and exposes the switch 41. Thereafter, the user may apply the user input to the switch 41 to activate the transmitter and to transmit the output signal to the device. Accordingly, such a key assembly 14 not only maintains the reduced length and/or width of the key assembly 15 in any position of the key and transmitter units 30, 40, but also blocks the user from accidentally actuating (or activating) the transmitter unit 40 while using the key unit 30 to turn on or off an engine of the vehicle.

Configurational or operational variations or modifications of the above exemplary embodiments of FIGS. 5A to 5D also fall within the scope of the present invention. For example, the key assemblies may also incorporate various coupling mechanisms described in conjunction with FIGS. 4E through 4H, except that such coupling mechanisms are arranged to operatively couple the mobile cover to one or both of the key and transmitter units. Similarly, such key assemblies may also include any combination of the foregoing recoil mechanisms, release switches, and/or variations described in conjunction with the key assemblies of FIGS. 4E to 4H.

In another aspect of the present invention and as exemplified in FIGS. 6A to 6F, exemplary key assemblies may include various disablers coupled to stationary key units and/or transmitter units and arranged to activate and disable the transmitter units. An exemplary key assembly 16 includes a body 20, at least one stationary key unit 30 identical or similar to those described in the foregoing figures, at least one transmitter unit 40 identical or similar to those disclosed in the foregoing figures, and at least one disabler 70 operatively coupled to the body 20, key unit 30 or transmitter unit 40, and arranged to be deactivated and activated. In particular, when the disabler 70 is deactivated (i.e., not selected by the user), it allows the switch 41 to receive the user input and to allow the transmitter to transmit the output signal. When the disabler 70 is activated (i.e., selected by the user), however, it is arranged to block the transmitter unit 40 from performing normal operations.

FIGS. 6A through 6F describe schematic diagrams of exemplary key assemblies incorporating various disablers capable of blocking normal operations of transmitter units according to this invention. In one embodiment and as exemplified in FIG. 6A, the disabler 70 may be arranged to be operatively coupled to the switch 41 so that, when activated, it may, e.g., block the switch 41 from receiving the user input, prevent the switch 41 from activating the transmitter, block the transmitter from generating or transmitting the output signal, and the like. In another embodiment and as exemplified in FIGS. 6B to 6F, the disabler 70 may include at least one sensor arranged to monitor or detect insertion of the key unit 30 into a lock assembly of a device such as a vehicle and then to disable the switch 41 and/or the transmitter of the transmitter unit 40 upon detecting such an insertion, thereby preventing the switch 41 from receiving the user input or from activating the transmitter and/or blocking the transmitter from generating and/or transmitting the output signal. Various conventional sensors may be incorporated to monitor or detect the partial or complete insertion of such a key unit 30 into a matching lock assembly. For example, such sensors may be arranged to measure or detect, e.g., a force applied thereto by the lock assembly (FIG. 6B), a torque applied thereto (FIG. 6C) by the user, a linear or radial displacement caused by the insertion (FIG. 6D), a distance to the lock assembly (FIG. 6E), presence of a conductive material or application of electric current or voltage (FIG. 6F), and the like. When such sensors sense the partial or complete insertion of the key unit 30 into the lock assembly, the disabler 70 receives the signal therefrom, prevents the switch 41 from receiving the user input or activating the transmitter or prevents the transmitter from generating or transmitting the output signal. Any conventional sensors may be employed to monitor or detect such an insertion of the key unit 30. For example, conventional force or torque transducers may sense the horizontal, vertical, lateral or radial force applied thereto, and conventional displacement sensors may monitor distances therefrom to a target such as, e.g., an exterior body of the lock assembly). Conventional voltmeters, amperemeters, and/or other electricity-sensitive elements may further be employed to detect electrical voltage thereacross, electrical current flowing therethrough, change in electric resistance, and the like. Other sensors capable of measuring existence of the lock assembly within a preset distance may be used to sense an upcoming insertion of the key unit 30.

In operation, when the user wants to remotely lock or unlock the lock assembly of the vehicle door or remotely perform other functions provided to the transmitter unit 40, the user applies the user input to the switch 41 of the transmitter unit 40 which is exposed on a top surface 25T of the body 20. The transmitter is then activated and transmits the output signal to the lock assembly of such a device. When the user desires to manually lock or unlock the door of the vehicle, he or she may simply insert the key unit 30 into the lock assembly of such a device. The disabler 70 detects the insertion and then disables the switch 41 and/or transmitter of the transmitter unit 40. Accordingly, such a key assembly 16 prevents the user from accidentally actuating (or activating) the transmitter unit 40 while using the key unit 30 to turn on or off an engine of the vehicle.

Configurational or operational variations or modifications of the foregoing exemplary disablers of FIGS. 6A to 6F also fall within the scope of the present invention. Such disablers may be arranged to mechanically, electrically, magnetically, and/or optically disable the switch and/or transmitter of the transmitter unit. For example, the mechanical disabler may be arranged to block the switch from any movement and, therefore, from receiving the user input even when the user directly applies such an input thereto. When the switch may be activated without any movement (e.g., touched or otherwise selected), such a switch may be disabled by the electrical disabler which may be arranged to open an electric circuit of or around the switch, when activated, such that the switch cannot receive the user input and/or cannot actuate the transmitter even when the user supplies the user input. The electrical disabler may also be arranged to prevent the transmitter from generating the output signal or block the transmitter from transmitting such a signal when activated. In addition, the electrical disabler may also be arranged to cut electric power to the switch and/or transmitter when activated, thereby preventing the transmitter unit from performing its normal functions or operations. When the transmitter unit may have multiple switches thereon, the key assembly may also include multiple disablers to selectively (or independently) disable different switches. In the alternative, the key assembly may include a single or only a few disablers each including multiple settings to selectively (or independently) disable different switches. In addition, the disabler may include multiple sensors so as to monitor multiple variables and detect the insertion of the key unit into the lock assembly and/or to independently or selectively disable multiple switches of the transmitter unit.

Such disablers may have various configurations to be selected by the user. For example and as shown in the figures, the disabler may be provided as a button which can be pressed, pushed in a preset direction, translated, tilted, swiveled, rotated, touched, and so on. Such a disabler may also be provided as a conventional toggle switch. When the disabler has multiple activation settings, it may be moved in different directions to disable different switches of the transmitter unit. When desirable, the aforementioned recoil mechanisms may be incorporated to activate, hold, and/or release the disabler.

In a further aspect of the present invention and as exemplified in FIGS. 6G and 6H, exemplary key assemblies may also include various switches of transmitter units on minor surfaces thereof. An exemplary key assembly 16 includes a body 20, at least one stationary key unit 30 identical or similar to those described in the foregoing figures, and at least one transmitter unit 40 identical to or similar to those disclosed in the foregoing figures. In particular, the body 20 includes a pair of opposing major surfaces (e.g., a top surface 25T and a bottom surface) and multiple minor surfaces (e.g., a distal end 25D, a proximal end, and sides), where the user generally touches and holds such major surfaces in manipulating the key unit 30. In such an embodiment, at least a substantial (or non-negligible) portion of the switch 41 of the transmitter unit 40 is disposed on the minor surface(s) to block (or minimize) the user from accidentally or unintentionally pressing or touching the switch 41 and thereby activating the transmitter unit 40.

The foregoing key assemblies and/or methods therefor of the present invention can be applied to any device of which the operations can be controlled by two or more different mechanisms, where one of such mechanisms may require a close disposition or a direct contact with the device for proper operations, while the other of such mechanisms can remotely control the same or similar operations of the device or does not require such a close disposition and/or direct or mechanical contact with such a device. As exemplified heretofore, one of such mechanisms may be conventional key units having multiple protrusions and/or indentations in a preset arrangement. The key units may also include other non-mechanical identification or verification means examples of which may include, but not be limited to, optical properties (e.g., color, degree of transparency, transmittivity, refraction index, and/or spatial arrangements of such properties), magnetic properties (e.g., magnetic strength, polarity, and/or spatial arrangements of such properties), electrical properties (e.g., conductivity, resistivity, electric charge, electric circuitry, and/or spatial arrangements of such properties), and the like.

In addition, the foregoing assemblies and/or methods therefor of the present invention may be provided by, e.g., combining any of the aforementioned (fixed and/or mobile) key units with any of the foregoing (fixed and/or mobile) transmitter units along with any of the foregoing optional covers, recoil mechanisms, temporal or spatial coupling mechanisms, curvilinear guides, axes of rotations, openings and/or receptacles, disablers, and the like. Accordingly, some of such key assemblies of the present invention may include no mobile unit, while other key assemblies of the present invention may include a single or multiple mobile units. Furthermore, some of such key assemblies may be arranged to have a fixed length or width regardless of the disposition of the mobile unit, whereas other key assemblies can have different length and/or width depending upon the disposition of the mobile units in their off-and/or on-positions.

It is to be understood that, while various aspects and embodiments of the present invention have been described in conjunction with the detailed description thereof, the foregoing description is intended to illustrate and not to limit the scope of the invention, which is defined by the scope of the appended claims. Other embodiments, aspects, advantages, and modifications are within the scope of the following claims.

1. A key assembly for directly and remotely locking and unlocking a door of a vehicle comprising:
a body;
at least one key unit having at least one of a preset shape, optical property, electrical property, and magnetic property, configured to lock and unlock said door of said vehicle based on said at least one of said shape and properties, and movably coupled to said body to move between an on-position and an off-position; and
at least one transmitter unit fixedly coupled to said body, having at least one switch configured to receive an user input and at least one transmitter configured to transmit an output signal responsive to said user input, and configured to remotely lock and unlock said door of said vehicle via said output signal.

2. The key assembly according to claim 1, wherein said key assembly is configured to define a length which is shorter when said key unit is in said off-position than when said key unit is in said on-position.

3. The key assembly according to claim 1, wherein at least a substantial portion of said key unit is configured to be exposed out of said body so as to allow said user to lock and unlock said door using said portion of said key unit in said on-position, and wherein at least a non-negligible portion of said key unit is configured to be disposed inside said body in said off-position.

4. The key assembly according to claim 3, wherein said body includes a receptacle and defines an axis of rotation, wherein said substantial portion of said key unit is configured to pivot about said axis in a first direction from said off-position to said on-position to dispose said substantial portion of said key unit out of said receptacle, and wherein said substantial portion of said key unit is configured to pivot about said axis along a second direction opposite to said first direction from said on-position to said off-position so as to dispose said substantial portion of said key unit inside said receptacle.

5. The key assembly according to claim 4, wherein said receptacle is configured to be defined at least one of on a surface of said body and between opposing surfaces of said body.

6. The key assembly according to claim 3, wherein said body is configured to have a receptacle, wherein at least a substantial portion of said key unit is configured to slide out of said receptacle from said off-position to said on-position so as to be exposed, and wherein said substantial portion of said key unit is configured to slide into said receptacle from said on-position to said off-position to dispose said substantial portion of said key unit inside said receptacle.

7. The key assembly according to claim 6, wherein said receptacle is configured to be defined at least one of on a surface of said body and between opposing surfaces of said body.

8. The key assembly according to claim 3 further including at least one recoil mechanism which is configured to store at least a portion of energy applied to move said substantial portion of said key unit from one to the other of said on- and off-positions and to release said energy to move said substantial portion of said key unit from said other to said one of said on- and off-positions.

9. The key assembly according to claim 3 further including at least one toggling mechanism which is configured to position said substantial portion of said key unit from one to the other of said on- and off-positions in an alternating mode in response to each application of energy to said key unit.

10. A key assembly for directly and remotely locking and unlocking a door of a vehicle comprising:
a body;
at least one key unit having at least one of a preset shape, optical property, electrical property, and magnetic property, configured to lock and unlock said door of said vehicle based on said at least one of said shape and properties, and movably coupled to said body to move between an on-position and an off-position; and
at least one transmitter unit movably coupled to said body, configured to move with respect to at least a portion of said body between an on-position and an off-position, having at least one switch configured to receive an user input and at least one transmitter configured to transmit an output signal in response to said user input, and configured to remotely lock and unlock said door of said vehicle via said output signal,

11. The key assembly according to claim 10, wherein said key assembly is configured to define a length which is shorter when said key unit is in said off-position of said key assembly than when said key unit is in said on-position thereof, and wherein said transmitter unit is configured to define a length which is shorter when said transmitter unit is in said off-position of said transmitter unit than when said transmitter unit is in said on-position thereof.

12. The key assembly according to claim 10, wherein both of said key unit and said transmitter unit are configured to move independently between their own on- and off-positions.

13. The key assembly according to claim 10, wherein said key and transmitter units are configured to be operatively coupled to each other such that one of said units is configured to move from said on-position to said off-position of said one of said units, whereas the other of said units is configured to move from said off-position to said on-position of said other of said units.

14. The key assembly according to claim 10, wherein at least a substantial portion of said key unit is configured to be exposed out of said body in order to allow said user to lock and unlock said door using said portion of said key unit in said on-position thereof, wherein at least a non-negligible portion of said key unit is configured to be disposed inside said body in said off-position thereof, wherein at least a substantial portion of said transmitter unit is configured to be exposed out of said body in order to allow said user to transmit said output signals using said portion of said transmitter unit in said on-position thereof, and wherein at least a non-negligible portion of said transmitter unit is configured to be disposed inside said body in said off-position thereof.

15. The key assembly according to claim 14, wherein said body includes a receptacle and defines an axis of rotation, wherein said substantial portion of said key unit is configured to pivot about said axis in a first direction from said off-position to said on-position to dispose said substantial portion of said key unit out of said receptacle, and wherein said substantial portion of said key unit is configured to pivot about said axis along a second direction opposite to said first direction from said on-position to said off-position so as to dispose said substantial portion of said key unit inside said receptacle.

16. The key assembly of claim 14, wherein said body is configured to have a receptacle, wherein at least a substantial portion of said key unit is configured to slide out of said receptacle from said off-position to said on-position so as to be exposed, and wherein said substantial portion of said key unit is configured to slide into said receptacle from said on-position to said off-position in order to dispose said substantial portion of said key unit inside said receptacle.

17. The key assembly according to claim 14 further including at least one recoil mechanism which is configured to store at least a portion of energy applied to move said substantial portion of said key unit from one to the other of said on- and off-positions and then to release said energy to move said substantial portion of said key unit from said other to said one of said on- and off-positions.

18. The key assembly according to claim 14 further including at least one toggling mechanism which is configured to position said substantial portion of said key unit from one to the other of said on- and off-positions in an alternating mode in response to each application of energy to said key unit.

19. A method of directly and remotely controlling operations of a device (or a vehicle) using a key assembly with a body comprising the steps of:
coupling to said body a transmitter unit capable of remotely controlling said operations;
coupling to said body a key unit capable of directly controlling said operations; and
spatially configuring at least one of said transmitter unit and said key unit to move between an exposed position and a hidden position;
controlling said operations of said device when said at least one of said units is placed in said exposed position; and
moving said at least one of said units to its hidden position upon completion of said operations, thereby reducing at least one of a total length and width of said key assembly than when said at least one of said units is in said exposed position.

20. The method according to claim 19, said step of spatially coupling including the step of spatially configuring both of said key and transmitter unit to move between their own exposed positions and hidden positions.
